(19) United States
(12) Patent Application Publication
(10) Pub. No.: US 2026/0296374 A1
(43) Pub. Date: Oct. 1, 2026

(54) SYSTEM AND METHOD FOR CLEANING WINDOWS AND LENSES IN AUTOMOTIVE APPLICATIONS

(71) Applicant: UUSI, LLC, Reed City, MI (US)

(72) Inventors: David W Baarman, Fennville, MI (US); Edward J. Cox, II, Marion, MI (US)

(21) Appl. No.: 19/095,359

(22) Filed: Mar. 31, 2025

(51) Int. Cl. B60S 1/48; B60S 1/50; B60S 1/52; F24H 1/14; F24H 15/215; F24H 15/25; F24H 15/258; F24H 15/37; H05B 6/10; H05B 6/42

(52) U.S. Cl. CPC B60S 1/485; B60S 1/488; B60S 1/50; B60S 1/52; F24H 1/142; F24H 15/215; F24H 15/25; F24H 15/258; F24H 15/37; H05B 6/108; H05B 6/42; F24H 2250/08

(57) ABSTRACT

A cleaning system with a monitoring and safety system that utilizes user input and sensors to detect cleaning requirements and is designed to provide user feedback on safety, cleaning status and efficacy. Also having an intrinsically decoupled inductive heating controller and water flow plates that are made of a conductive material designed to enable inductive heating of fluid to allows transfer to surfaces. This surface cleaning system can include both physical and ultrasonic energy to enable better cleaning and clearing efficacy. It is connected to a CAN system that enables a communications protocol for sharing user interface and feedback.

### BACKGROUND OF THE INVENTION

The present invention relates to automotive systems, and more specifically to an automotive cleaning system that utilize fluid for cleaning windshields and lenses for onboard visions systems.

Automotive vehicles often encounter a variety of environmental conditions that can adversely affect their performance and safety. One such challenge is the accumulation of debris, frost, ice, and snow on vehicle windshields, which can impair visibility for the driver. To mitigate these issues, windshield washer systems are commonly employed. These systems spray washer fluid onto the windshield to clean off dirt and debris or assist in the removal of frost and ice.

Conventional windshield washer systems, while effective in many conditions, often exhibit diminished performance in colder climates. In freezing temperatures, washer fluid may fail to adequately remove ice or frost from the windshield. Additionally, the washer fluid itself can freeze within the system, rendering the system inoperable until the fluid is thawed. These limitations can compromise driver safety, particularly in regions where severe weather conditions are common.

Modern vehicles are increasingly equipped with advanced driver assistance systems (ADAS) that rely on sensors such as forward-looking cameras and radar systems. These sensors are often positioned in areas exposed to the elements, making them susceptible to the accumulation of dirt, ice, and other debris. Obstructions on sensor lenses can significantly degrade their performance, reducing the effectiveness of critical safety features such as adaptive cruise control, lane-keeping assistance, and emergency braking systems. Cleaning these lenses is essential to maintain the functionality and reliability of ADAS, especially in adverse weather conditions.

To address these shortcomings, various methods have been proposed to heat windshield washer fluid and other cleaning fluids prior to its application. Existing systems include engine heat exchangers, electric heating elements, and separate fluid heating reservoirs. While these approaches have shown promise, they are not without their drawbacks. For example, engine heat exchangers may require prolonged vehicle operation to reach an effective temperature, delaying their functionality. Electric heating systems, on the other hand, present a number of known risks associated with the use of electricity in close proximity to liquid. Conventional systems have been restricted to relatively low fluid volume or have suffered from high cost due to the high power of heaters and drivers. Accordingly, existing electric heating systems have limitations in size, cost and readiness time of the solution. The net result is that prior art systems are complex and costly to manufacture, limiting their widespread adoption.

Thus, there remains a need for an improved system for heating fluid used to clean windshields and sensor lenses that offers rapid and efficient operation, minimal impact on vehicle systems, and cost-effective implementation. Such a system would enhance windshield washer and sensor performance in cold weather, improving visibility and driver safety.

### SUMMARY OF THE INVENTION

The present invention provides a fluid cleaning system for automotive applications that has an induction heating system for heating cleaning fluid, such as windshield washer fluid, prior to application. The induction heating system provides a level of physical and electrical separation between the cleaning fluid and the electrical power, thereby isolating the cleaning fluid from direct electrical power. The physical space allows plastics or other sealing between the electrical components and the heat exchanger providing an added layer of safety and reliability between the system components.

In one embodiment, the system includes an induction heating system having a heat exchanger that includes an extended fluid flow path. In operation, the induction heating system generates heat within the heat exchanger by electromagnetic induction which, in turn, heats fluid disposed within or passing through the fluid flow path. The heat exchanger may, for example, define a serpentine flow path and be manufactured from a ferromagnetic material, a conductive material or another material that generates heat when subjected to an appropriate electromagnetic field. The heat exchanger may, for example, be almost any aluminum, tin, carbon steel or stainless steel, and control of the induction circuit may be adjusted to operate at the appropriate frequency for the selected material and heat exchanger configuration. This can be determined by testing the heat exchanger in the lab at different operation characteristics.

In one embodiment, the heat exchanger is arranged in the flow path between a cleaning fluid reservoir and the discharge nozzle (or nozzles). The fluid may be selectively heated as it dwells within or passes through the heat exchanger on its movement from the fluid reservoir to the discharge nozzle(s), and the amount of energy inductively supplied to the heat exchanger may be controlled to provide the desired fluid temperature.

In one embodiment, the heat exchanger is formed from stamped sheet material, such as sheet metal or other materials that are capable of being heated by electromagnetic induction, which are shaped and joined together to define one or more fluid flow paths. In such embodiments, a fluid flow path or a plurality of fluid flow paths are defined by contours formed into one or more of the stamped sheets. The sheets may be joined by welding or other similar methods.

In one embodiment, the heat exchanger includes a flow path defined by a tubular coil of conductive material or another material that heats in the presence of an electromagnetic field. In operation, the system may be configured such that the material forming the coil is heated by electromagnetic induction, which in turn heats the fluid passing through the flow path.

In one embodiment, the heating system includes a control and an induction coil that cooperatively generate an electromagnetic field. The control system is configured to control the operation of the heating system to intelligently and efficiently heat the cleaning fluid. The control system may include a driver that applies electrical power to the induction coil to create a time-varying magnetic field. The control system may be configured to regulate power, frequency and other parameters to optimize efficiency and achieve the desired level of heating.

In one embodiment, the control system is configured to initiate operation of the cleaning system in response to signals from one or more sensor system. Operation may occur automatically or the system may solicit permission from the user to perform a cleaning operation. For example, a sensor system may be configured to detect when it is not functioning properly. In the context of a lens for a radar antenna, the radar control system may send a message to the control system when it determines that an excessive amount of radar signals are returning from a range of zero to X (where X is approximately the distance of the lens from the radar antenna). This may suggest that dirt, snow or ice have built up on the lens. Based on pre-configured settings, the user may be alerted to press a cleaning button or the system may respond automatically with a cleaning cycle. The percentage difference resulting from the cleaning cycle is noted and the cleaning cycle may be automatically altered or recycled for a specific ratio of expected efficacy per cycle using ongoing sensor feedback.

In one embodiment, the control system uses outside temperature and fluid temperature to determine whether heating is needed and, if so, the energy required to be introduced into the system to heat the fluid to the desired temperature. In some applications where the fluid cannot be heated to the desired temperature in a single heating cycle (e.g. because the automotive system does not have sufficient power), the system may also determine the number of cycles needed to get the temperature to the desired target temperature. The heat exchanger temperature may be considered over time to determine the energy taken out of the system and the stored thermal energy in the system.

In one embodiment, the fluid cleaning system incorporates a heat sink capable of retaining heat between operating cycles. As a result, the system is capable of producing a temperature build-up in the fluid over consecutive cycles. In one embodiment, the heat exchanger functions as the heat sink. For example, the heat exchanger may be manufactured from conductive material with enough heat retention capacity to require more time than a single operating cycle at anticipated power levels to reach peak temperature.

In one embodiment, the induction coil used to supply inductive energy to the heat exchanger also includes a fluid flow path through which the cleaning fluid is routed prior to entering the heat exchanger. During normal operation, the inductive coil can be heated to an undesirable degree by the flow of electricity through the coil and by heat emanating from the adjacent heat exchanger. By providing the inductive coil with a fluid flow path upstream from the heat exchanger, the system obtains the combined benefits of preheating the cleaning fluid (prior to entry into the heat exchanger) and cooling the inductive coil.

In one embodiment, the inductive coil is formed by tubing (or tube) of ferromagnetic or conductive material, and the fluid is routed through the interior of the tubing before it passes into the heat exchanger. In some applications, it may be desirable to coat or line the inside of the tubing with an insulative material to electrically insulate the fluid from the electrical power in the inductive coil. In this embodiment, the fluid flow path is integrated into the inductive coil, but it may in alternative embodiments be separate from the inductive coil. For example, in alternative embodiments, the fluid flow path may be formed by a hose or tube wrapped about or extending adjacent to the inductive coil.

In one embodiment, the cleaning system includes a pump that moves fluid through the system. To enhance cleaning performance, the pump may be modulated, for example, with pulses. The characteristics of the modulation, such as frequency, amplitude and on/off times, may be selected to provide enhanced performance, and may be varied over time as desired. In one embodiment, modulation of the pump is controlled to produce a water hammer effect giving the fluid greater energy that enhances cleaning.

In one embodiment, the cleaning system includes an ultrasonic module that is configured to inject ultrasonic energy into the system. In one implementation, the ultrasonic module may be configured to inject ultrasonic energy into fluid. For example, the ultrasonic module may include an ultrasonic piezo element (or elements) that introduces ultrasonic vibrations into the fluid. The ultrasonic piezo element(s) may be disposed essentially anywhere along the fluid flow path from the reservoir to the nozzles, but in some applications one or more piezo elements are located at or near the nozzle(s) to optimize the amount ultrasonic energy that remains in the fluid as it impinges on the windshield or lens to be cleaned. In other implementations, the ultrasonic module may be configured to inject ultrasonic energy into the windshield or lens. For example, a piezo element (or a plurality of piezo elements) may be disposed at or near the windshield or lens to create ultrasonic vibrations in the windshield or lens. In some applications, ultrasonic energy may be introduced into the fluid and the windshield/lens.

In one embodiment, modulation of the pump and injection of ultrasonic energy may be designed out of phase to provide a scrubbing-like motion at the surface to remove debris. For example, the pump may be modulated with on/off pulses and ultrasonic energy may be introduced into the fluid during one or both of the on/off phases, and ultrasonic energy may be introduced into the windshield or lens during one or both of the on/off phases to introduce energy into the system at the windshield/lens. Any combination of these effects may have a beneficial effect and the decision on what to integrated into a given system may be a balance of cost against cleaning requirements. The system may incorporate ultrasonic transducers/transmitters of different sizes, with larger transducers/transmitters typically providing greater energy, but coming at greater cost.

In one embodiment, the cleaning system may be configured to obtain heat from one or more automobile components, such as the engine, radiator, exhaust, battery cooling and other sources of thermal energy. For example, the cleaning system may include a heat exchanger that is positioned to obtain thermal energy from one or more automobile components. A volume of fluid may be routed through this heat exchanger to heat the fluid. As the automobile heats, the amount of thermal energy available from the automobile heat exchanger may be more than desired, presenting a risk that the fluid is overheated (for example, causing it to boil). To address this, the cleaning system may include a control system capable of blending a volume of fluid from the reservoir with a volume of water passing through the automobile component heat exchanger. The control system may be configured to control the precise ratio of fluids to provide an effluent fluid at the desired temperature. In one embodiment, the system include two different pumps, one for moving fluid from the reservoir without passing through the automobile heat exchanger and another for moving fluid from the reservoir through the automobile heat exchanger. The two pumps may be controlled by a pulse-width-modulation (“PWM”) controller that controls the flow rate of each pump to adjust fluid temperature to a precise delivery target temperature. A proportional-integral-derivative (“PID”) algorithm can be used to control the temperature output and input ratios to assure proper temperature delivery.

In one embodiment, the control system may include a fluid monitoring system that uses thermal trajectory in the heat exchanger as a factor in controlling the supply of inductive energy to the heat exchanger. By watching the thermal trajectory with a given amount of energy this system accurately determine the presence of fluid within the heat exchanger. When the fluid is present, a slower rise in the overall core temperature occurs. When the fluid is not present, fast heating occurs and there may be a need to turn down or shut off the system to avoid causing fluids in the system to boil or otherwise reach undesirable temperatures.

In one embodiment, the cleaning system includes a fully insulated and sealed heat exchanger, and the induction coil(s) is completely external to the heat exchanger.

In one embodiment, the driver for the system can range from 350 watts to 3 kilowatts. The configuration of the driver may vary from application to application. For example, it may be a half bridge or a full bridge driver in different applications. The driver may, for example, have an H bridge or a flyback configuration. In some applications, the driver may be a resonant-type driver, and it may adjust to the tuned frequency of the material being heated. The drive may, in some applications, include a current sensor that monitors the peak power to ensure the system is tuned properly. The information from the current sensor may be used for diagnostics and troubleshooting. In some applications, the control system or the driver may be configured to sweep through a range of frequencies to detect peak power for best energy transfer during operation.

In one embodiment, the present invention provides a heating system that includes a fluid reservoir containing a cleaning fluid, a heating chamber separate from the fluid reservoir, a nozzle through which heated fluid is dispensed, fluid supply lines that couple the fluid reservoir to the heating chamber and the heating chamber to the nozzle and a control system configured to move a volume of fluid from the fluid reservoir to the heating chamber, heat the volume of fluid in the heating chamber in isolation from the bulk of fluid in the reservoir and then dispense the heated fluid. In one embodiment, the cleaning fluid is moved using a pump, with the control system configured to periodically operate the pump to move an appropriate volume of fluid into the heating chamber, to allow the cleaning fluid to dwell in the heating chamber to allow it to heat over time and then to operate the pump to dispense an appropriate volume of heated fluid through the nozzle. In one embodiment, the heating chamber is an induction heat exchanger that is heated by an electromagnetic field. The heat exchanger may include a metal tube through which the cleaning fluid is routed between the fluid reservoir and the nozzle. In one embodiment, the metal tube may be arranged in a coil to provide a serpentine flow path for the cleaning fluid.

The present invention provides solutions to past problems that have been observed and modified for better results in the production environment. The present invention improves the ability to clear sensors and the windshield for optimal, optics and sensor feedback. Ice, dirt, bugs and debris can limit optics and functional sensor operation. The present invention provides efficient and effective heating of cleaning fluid while allowing isolation between the electrical components and the fluid. The heat exchanger and induction heating system may be configured to provide quick heating and to allow a build-up in fluid heat over consecutive cleaning cycles. The control system may be configured to monitor ambient temperature and system temperature to use those readings in determining when and how to operate the heating system. The present invention may be configured to modulate the pump to pulse or otherwise vary fluid discharge, thereby improving effectiveness of the cleaning cycle. The pulsing may be tuned to provide a water-hammer effect that further improves cleaning. The present invention may also utilize ultrasonic energy in the fluid and/or the windshield/lens to facilitate the breakdown of snow, ice, dirt, dust and debris and thereby enhance cleaning. In some applications, the cleaning fluid can be used to cool the induction coil. By automating, the system can control a faster and more controlled cleaning and heating solution for better customer satisfaction. Estimating the usage and situation regarding freezing can help to assure residual energy is kept in the system for faster rise times and more energy to apply to the surfaces.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a representation of an automotive fluid cleaning system with an on-demand induction heating system in accordance with an embodiment of the present invention.

FIGS. 2A-C are illustrations of a heat exchanger in accordance with an embodiment of the present invention.

FIG. 3 is an illustration of an alternative heat exchanger with an outer tubular sleeve shown as transparent to show the internal coil.

FIG. 4 is representation of an alternative automotive fluid cleaning system with an on-demand induction heating system in accordance with an alternative embodiment of the present invention.

FIG. 5 is a block diagram of a control system for heating and cleaning windows and lenses in accordance with an embodiment of the present invention.

FIG. 6 is an illustration of fluids being dispensed onto a windshield.

FIG. 7A is a block diagram of a control methodology for proactively cleaning a window or lens.

FIG. 7B is a block diagram of a control methodology for reactively cleaning a window or lens.

FIG. 8 is a representation of a second alternative automotive fluid cleaning system in accordance with an alternative embodiment of the present invention.

FIG. 9 is a plot of output fluid temperature against time comparing several power schemes.

FIG. 10 is a plot of output fluid temperature against time comparing two power schemes with different operating wattages.

FIG. 11 is a plot of output fluid temperatures against time of an exemplary power scheme over seven consecutive cycles with a 30 second preheat time.

FIG. 12 is a plot of output fluid temperature against time of an exemplary power scheme over seven consecutive cycles with a 45 second preheat time.

FIG. 13 is a first series of infrared pictures of the heat exchanger over time.

FIG. 14 is a second series of infrared pictures of the heat exchanger over time.

FIG. 15 is a graphic representation of an exemplary control algorithm for preheating and monitoring the preheat and thermal cycling during operation.

FIG. 16 includes illustrations of various alternative coil arrangements.

FIG. 17 is a circuit diagram of a control system for a programmable induction heater.

FIG. 18 is a graph showing the power response of various types of metal.

FIG. 19 is a circuit diagram of a flyback circuit suitable for use with the present invention.

FIG. 20A is a side view of a sleeve for a heat exchanger.

FIG. 20B is an end view of the sleeve.

FIG. 20C is a side view of a fluted core for a heat exchanger.

FIG. 20D is an end view of the fluted core.

FIG. 21A is a perspective view of an alternative heat exchanger core.

FIG. 21B is a perspective view of another alternative heat exchanger core.

FIG. 22 is a perspective view of an end cap for a heat exchanger.

FIG. 23 is a perspective view of a Kapton tape bobbin and a Kapton tape bobbin on a structure representative of a core.

FIG. 24 is a perspective view of a Kapton tape bobbin on a structure representative of a core.

FIG. 25 shows a plurality of alternative stamped sheets capable of being assembled to form various heat exchangers.

FIG. 26 is a perspective representation of another alternative heat exchanger using a helically wound flat spring.

FIG. 27 shows various alternative coils of tubing of different sizes.

FIG. 28 is a representational view of a nozzle and lens with piezoelectric elements on the nozzle and the lens.

FIG. 29 is a representational view of a nozzle and lens with a piezoelectric element on the nozzle.

FIG. 30 is a representational view of a nozzle and lens with a piezoelectric element on the lens.

### DESCRIPTION OF THE CURRENT EMBODIMENT

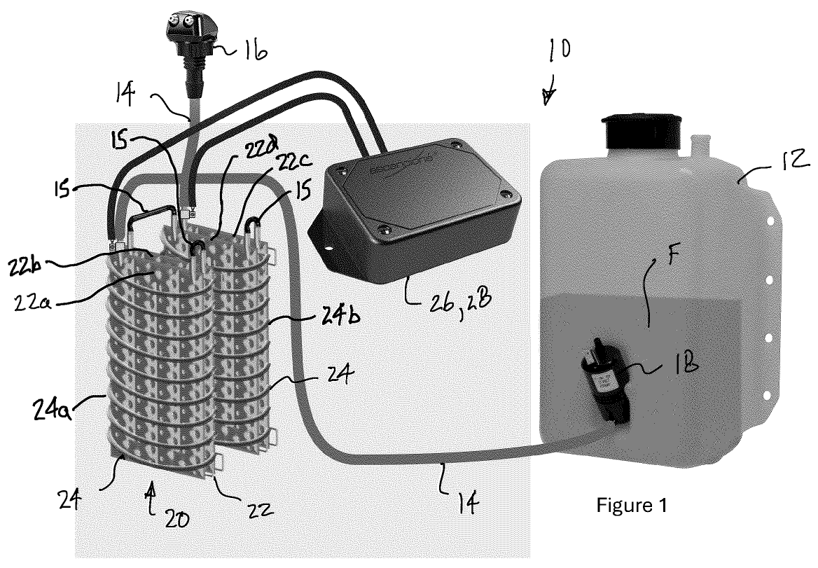

An automotive fluid cleaning system with an on-demand induction heating system is shown in FIG. 1 and generally designated 10. The fluid cleaning system 10 of FIG. 1 generally includes a fluid reservoir 12 for retaining fluid F, a plurality of fluid transfer lines 14 for guiding the flow of fluid F through the system 10, a nozzle 16 for discharging fluid F (for example, onto a windshield or lens), a pump 18 for moving fluid through the system 10 and an induction heating system 20 for heating the fluid. The induction heating system 14 generally includes a heat exchanger 22, one or more induction coils 24 and a controller 26 that controls operation of the induction heating system 20. The controller 26 in this embodiment includes a driver 28 for applying electrical power to the induction coil(s) 24. The induction coil(s) 24 generate an electromagnetic field that heats the heat exchanger 22 through induction. The inductively heated heat exchanger 22, in turn, heats fluid F as it flows through the heat exchanger 22. The controller 26 of this embodiment also includes temperature sensing and safety logic that allows for efficient and intelligent heating of the heat exchanger 22, and consequently the fluid F. In operation, the heating system 20 of this embodiment is configured to obtain input from one or more temperature sensors and/or other safety sensors, and then to engage/disengage the heating system 20 to heat the fluid F as determined by the controller 26, in part, as a function of the sensor input. Various alternative control algorithms are discussed in more detail below in connection with different embodiments of the present invention. In the embodiment illustrated in FIG. 1, the heat exchanger 22 includes four heat exchanger panels 22a-d that are arranged so that fluid F flows through them in series. Each panel 22a-d is manufactured from two joined sheets of stamped material that are shaped to define a serpentine or circuitous flow path. At least one of the sheets is manufactured from a material that heats in the presence of the electromagnetic field generated by the induction coil 24. For example, one or both sheets may be stamped from aluminum, tin, carbon steel or stainless steel, and control of the induction circuit may be adjusted to operate at the appropriate frequency for the selected material and heat exchanger configuration. This can be determined, for example, by testing the heat exchanger 22 in the lab at different operation characteristics.

In the embodiment of FIG. 1, the heat exchanger 22 includes four panels (22a-d), but the number of panels may vary from application to application. For example, some applications may include a single panel while others may include any desired number of panels. When multiple panels are includes, the panels may be arranged in series, parallel or series-parallel. However, in some applications, it has been determined that a series arrangement of the panels provides better heating performance. The volume of the heat exchanger 22 may vary from application to application, but in the illustrated embodiment has a volume of about 140-160 ml. In other embodiments, the heat exchanger may be manufactured using other techniques and apparatus.

In the embodiment of FIG. 1, the panels are arranged in pairs with a first induction coil 24a wrapped about the first pair of panels 22a, 22b and a second induction coil 24b wrapped around the second pair of panels 22c, 22d. As shown, adjacent heat exchanger panels are coupled by intermediate fluid supply lines 15 that link adjacent panels and cause the fluid to move through the panels in series. In this embodiment, the first induction coil is wrapped around the first pair of panels from top-to-bottom and the second induction coil is wrapped around the second pair of panels from bottom-to-top. The first end of the first induction coil is coupled to the driver and the second end is connected to the first end of the second induction coil. The second end of the second induction coil is coupled to the driver. As such, the first and second induction coils are arranged electrically in series.

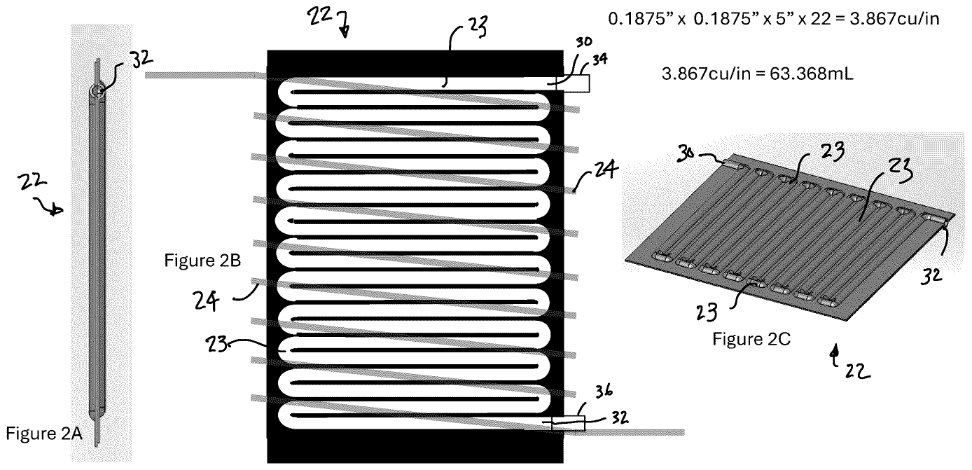

FIGS. 2A-C show a heat exchanger 22 (or heat exchanger panel 22a or 22b) that is manufactured from two stamped sheets. The two sheet are mirror images of one another and are configured to cooperatively define a serpentine flow path 23 that extends through a larger portion of the sheets. The sheets are joined face-to-face by any desired method, such as brazing, welding, adhesive bonding, diffusion bonding or other techniques that provide a sufficiently leaktight flow path 23. While the illustrated heat exchanger includes a single serpentine flow path 23 that extends over nearly the entire surface area of the heat exchanger, alternative implementations may include two or more separate flow paths that are arranged in series, parallel or series-parallel. The heat exchanger 22 includes a first fluid opening 30 at one end of the flow path 23 and a second fluid opening 32 at the opposite end. Inlet and outlet fittings may be installed in the first fluid opening 30 and the second fluid opening 32 to facilitate attachment of fluid lines. For example, an inlet fitting 34 may be installed in the first fluid opening 30 and an outlet fitting 36 may be installed in the second fluid opening 32 (See FIG. 2B). The fittings 34 and 36 may be secured, for example, by welding, adhesive bonding, diffusion bonding or other techniques that provide a sufficiently leaktight connection. Referring again to FIG. 1, these fittings may be used to join to a supply line coming from the fluid reservoir, an adjacent panel or a fluid supply line running the nozzle. FIG. 2B shows an induction coil 24 wrapped in a loose spiral about the exterior of the heat exchanger 22. The illustrated size of the wire, the number of wraps and the spacing between adjacent wraps is merely exemplary.

In the embodiment of FIG. 1, the induction coil 24 is wrapped about the stamping(s) to enable proper induction heating. The induction coil 24 may be formed by an arrangement of conductive material, such as a coil or spiral of solid or stranded wire. The type and gauge of wire may vary from application to application, but the embodiment of FIG. 1 includes 16 gauge solid copper wire. The number and shape of the turns in the coil may vary from application to application. In the illustrated embodiment of FIG. 1, the induction coil 24 includes 9 or 10 turns about each of the heat exchanger panels 22a, 22b. When the heat exchanger 22 includes multiple panels, a single induction coil may be wrapped about all of the panels or separate coils may be wrapped about each separate panel (or some combination thereof). When multiple coils are provided, they may be arranged electrically in series, parallel or series-parallel.

In the embodiment illustrated in FIG. 2B, the coils are distributed evenly to evenly distribute the electromagnetic field. However, in alternative embodiments, the coils (or individual turns in the coils) may have an uneven distribution to vary the distribution of the electromagnetic field. For example, closer turns may be used where more field strength is desired and turns with increased spacing may be used where less field strength is desired. The fluid path allows the buildup of thermal energy as the fluid moves through the system to the exit. This aspect of heating as it flows helps to save energy and build upon energy in the system. When a heat exchanger is implemented with more than one heat exchanger panel, the panels are typically connected in series and may have an insulating and protective layer (not shown) that the coil fits about. In some applications, the coil will be contained within a protective bobbin and cover so that the coil is completely separated from the panels thereby adding to the intrinsic safety associated with separating fluids from high power electronics.

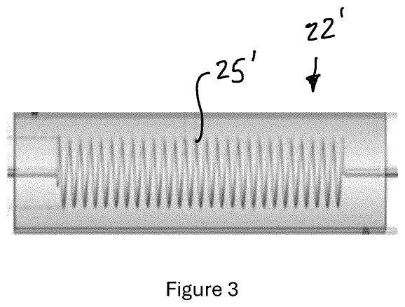

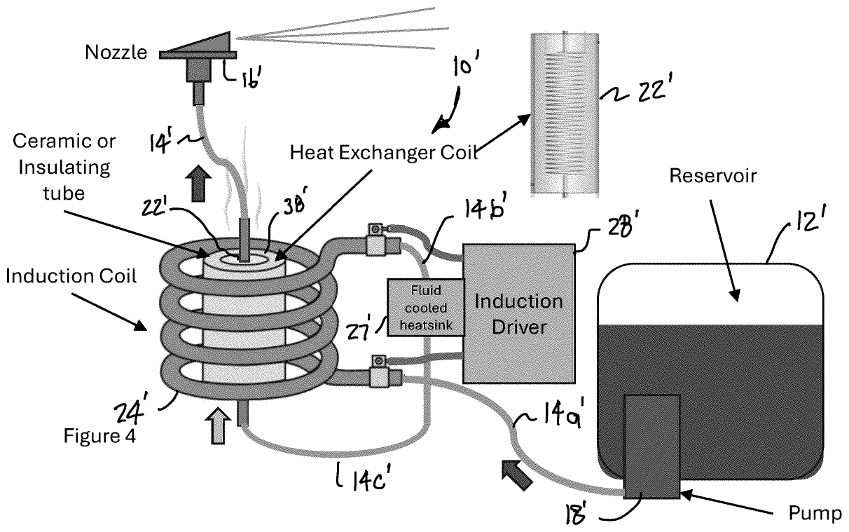

As an alternative to stamped sheets, the heat exchanger may incorporate a tubular fluid flow path that is wrapped or otherwise formed in a coil or other serpentine arrangement (See FIG. 3). The tubular flow path may be manufactured from a material that is heatable through induction. For example, the heat exchanger 22′ may include a coil 25′ or otherwise serpentine arrangement of copper, steel or aluminum tubing. Although the embodiment illustrated in FIG. 3 include tubing wrapped into a single coil 25′, the tubing may be wrapped in other configurations. For example, an extended flow path can be provided by using a multilayer spiral coil, which is tightly wound and tightly stacked to essentially fill the volume available to the heat exchanger. The inner and outer diameters of the tubing may be selected to provide an efficient and effective balance between the volume of fluid and the amount of heat exchanger material given the characteristics of the induction field generated by the induction coil. Unheated fluid enters the coil at one end and exits through the other. In use, heat generated in the heat exchanger 22′ by induction heating spreads from the tubing into the fluid F contained in the coil 25′. Given the power limitations associated with typical automotive applications, a period of preheating of the heat exchanger 22′ and a period of dwell may be implemented to allow the fluid F to reach the desired temperature at each consecutive cycle. To that end, the control system may begin a cleaning cycle by preheating the heat exchanger for a desired period of time. This will typically occur after the control system has operated the pump to move the desired volume of fluid into the coil, though it could occur before. The pump can be stopped while fluid F is contained within the heat exchanger 22′, thereby causing the fluid F to dwell in the heat exchanger 22′ for essentially any amount of time determined appropriate for heating the fluid. Additionally or alternatively, the coil may be embedded within or surrounded (fully or partially) by a material that is heatable through induction. The heat from the surrounding material may flow into the coil to heat fluid F passing therethrough. In some alternative embodiments, the tubular flow path is manufactured from a material that is not heatable through induction, but that obtains its heat from a surrounding material that is heatable through induction. If desired, the coil and any surrounding inductively heatable material may be surrounded by an insulating material, such as insulating tube 38 as shown in FIG. 4. In this embodiment, the insulating tube 38′ is a ceramic material that is not heatable by induction and is able to withstand the heat generated by the coil and/or any surrounding material.

In the embodiment of FIG. 4, the system uses the unheated cleaning fluid to optionally first cool the driver and the induction coil (though in some applications the system may be configured to cool just the coil or just the driver). In some applications, this cooling arrangement may not be required and it may be avoided when it is more favorable to separate out the electronics from fluids definitively. Referring now to FIG. 4, the system 10′ generally includes a fluid reservoir 12′, a pump 18′, a heat exchanger 22′, an induction coil 24′, an induction driver 28′, a nozzle 16′ for dispensing fluid onto a surface (e.g. a windshield, window or lens), and a plurality of fluid lines 14′. In this embodiment, the heat exchanger 22′ may be implemented as a coil of tubing as shown in FIG. 3. The coil of tubing may be disposed within an outer layer of insulation, such as ceramic sleeve 29′. In this embodiment, the induction coil 24′ is manufactured from tubing, such as hollow steel or copper tubing. The fluid lines 14′ are configured to move the fluid F through the induction coil 24′ and the heatsink 27′ on the induction driver 28′ before the fluid F is moved through the heat exchanger 22'. Two of the benefits of this configuration is that it helps to cool the induction coil and induction driver, which have a tendency to heat up during use, and to preheat the fluid F so that it is at a higher temperature when it enters the heat exchanger 22′ for heating. As shown, a first fluid line 14a′ can introduce fluid F into one open end of the tubing, a second fluid line 14b′ can move fluid F from the internal of the tubing over the heatsink 27′, and a third fluid line 14c′ can connect the heatsink 27′ to the inlet end of the heat exchanger 22′.

When the washer fluid pump is initiated by triggering the pump the system starts the driver that inductively heats the heat exchanger. In this embodiment we show a coil within an insulating sleeve. In cold weather situations the temperature control can preheat the 140 ml of water in the plates giving the system a start at the heating so that the upper temperature can be sustained faster and longer. The induction coil is intrinsically separated from the fluid plates or manifold being heated. The pump delivers the fluid through the system at a given rate of flow to the nozzle(s). The system is designed to heat the fluid as it is flowing. The system may preheat this heat exchanger prior to triggering the pump to invest energy into the system for extraction later in the process. Insulating material may be ceramic, fiberglass, glass filled plastic or other material allowing the energy to have a barrier from the environment. The reservoir holds the fluids to be heated. Temperature sensors may be used for ambient temperature, fluid in and out temperatures to control and regulate the fluid application properly. Ambient temperatures are also used to determine if it is desirable to preheat the fluids. For example, on very cold days the system will want to increase fluid temperature to have the maximum impact on the surfaces with the optimal fluid temperatures. As a practical matter, this can be difficult with the energy allowed in a typical automotive system. When operating under these constraints, the heating system uses inductive power over time to provide optimal efficiency in the heating and energy distribution process. For example, the system may operate for one or more cycles with suboptimal temperatures as the system builds temperature over time to eventually reach the optimal temperature. In some embodiments, the system is designed to reach an optimal temperature in three or less cycles when facing typical cold temperatures. However, it may take the system more than three cycles to achieve optimal temperature in excessive cold external temperatures.

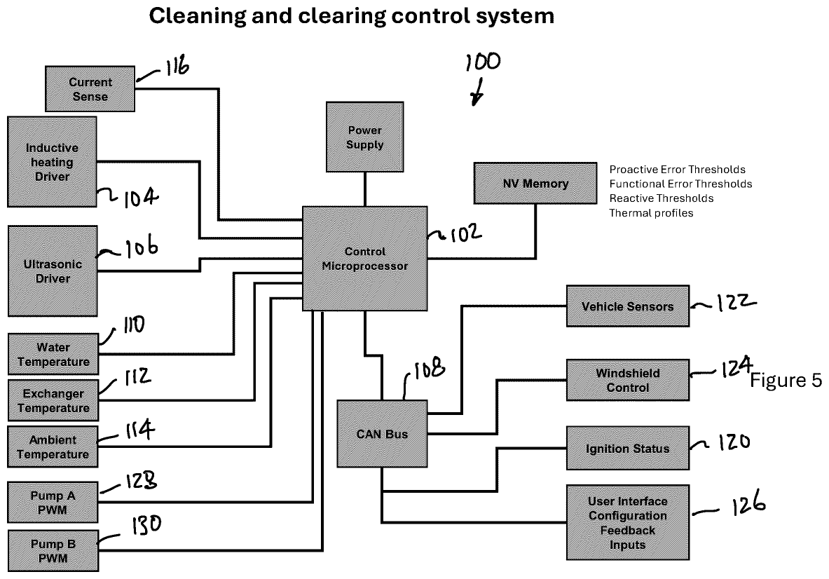

FIG. 5 shows a control system 100 for heating and cleaning windows and lenses in a transportation vehicle. The control microprocessor 102 controls the inductive heating driver 104, the ultrasonic driver(s) 106 and the Can Bus communications 108. Temperature sensors of the fluid in (water temperature 110) and out (exchanger temperature 112) and the ambient sensor (ambient temperature 114) are used to determine if and how the system should be used and when/how to heat and operate the ultrasonics. The current sensor 116 is designed to be on the input to the circuit for monitoring overall current. It will allow tuning the inductive heating driver 104 for optimal power and also serve as a limit-essentially enabling a solid state breaker or fuse. If the current is too high, the control microprocessor 102 can shut off the drivers 104 and 106. It is designed to monitor the thermal rise based on ambient and fluid temperature to determine if the fluid is present or if the fluid is empty. If the temperature rise is too rapid for the ambient temperature, the system can be configured to assume issues in the flow of fluid. This limits wasted energy and prevents micro boiling of limited fluid in the system. The system may also include one or more pumps for moving fluid through the system. In the embodiment of FIG. 5, control system 100 includes motor drivers (Pump A PWM 128 and Pump B PWM 130) that are configured to modulate the pump(s) and or change the speed of the fluids to help in temperature control. In some applications, the modulated energy adds to the cleaning efficacy by creating a higher force delivered to the surface to be cleaned. The ultrasonic driver 106 may be designed to deliver the inverse energy in a push-pull like fashion to enhance the ultrasonic energy available on the surface. This can be ultrasonically delivered or a combination of physical pulsing and ultrasonic energies tuned for optimal harmonics and physical scrubbing. The Can Bus communications 108 enable the control microprocessor 102 to access ignition information 120, vehicle sensor information 122, weather condition information and other required sensor data. It may also allow the user control system to understand the status of and operate the windshield control 124, such as the windshield wipers. Further, the CAN Bus communications 108 may enable control system 100 to receive user configuration settings and other feedback inputs that might be entered on a remote user interface 126, such as via a touch screen positioned in the center console. In very cold weather situations, the preheat may start the moment the car is running to attempt to make the system ready for clearing the windshield.

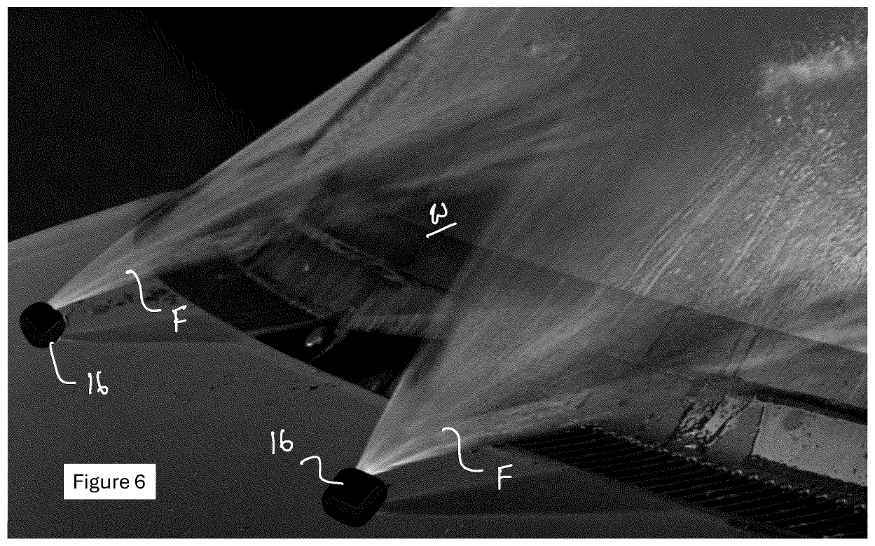

FIG. 6 shows an application of the heated fluid on a windshield. The two nozzles 16 are spraying warm fluid F onto the windshield W, not too hot to break the window but hot enough to clear frost and ice quickly. Temperature limits for a range of different windshields are determined in the lab, and temperature limits with a margin of safety may be implemented. Typically, the fluid is delivered to the surface between 120° F. and 150° F. for optimal impact for snow and ice. The system may also compensate for the losses in the lines and shoot for a delivered temperature based on the assumption that there will be substantial losses, for example, about 10° F. per foot of washer tubing. The system parameters may be preprogrammed into the configuration so that the temperature overshoot would be part of the thermal target. The system may be configured to apply the proper energy to heat these fluid lines given a volume of fluid. For example, the system may include a look up table based on the configuration of heat exchanger established by testing and optimization over various temperatures and conditions. This along with the ambient temperature and distance to the nozzles may, in some embodiments, be part of a dynamic algorithm that enables constant delivery temperatures for optimal cleaning and clearing. In this embodiment, the cleaning system may include a simple PWM motor control (not shown) that enables the dispensed fluid to pulsate, for example, at a predetermined frequency. This additional energy serves two purposes, it limits the consumption of fluid allowing the thermal system to keep an optimal temperature and also delivers more physical energy to the surface assisting in clearing the surface.

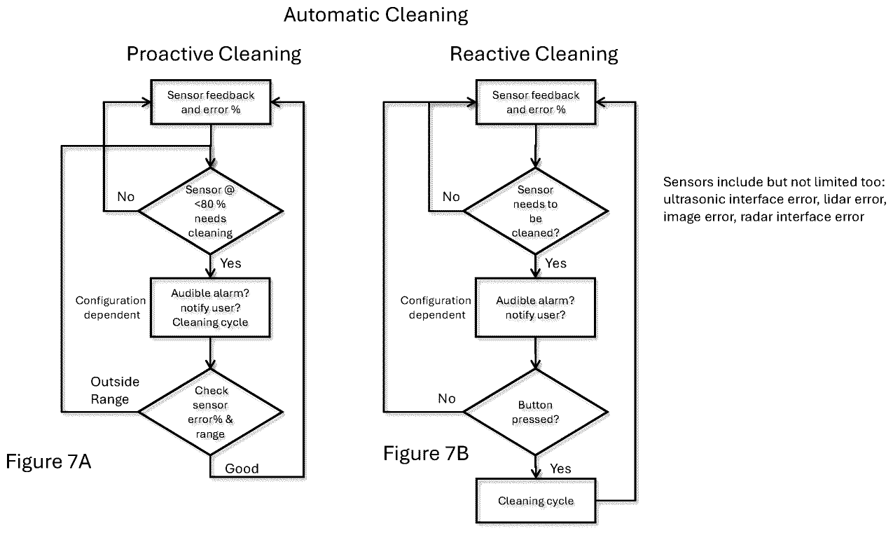

FIG. 7A shows the control methodology of a system capable of proactively cleaning sensors and surfaces. The system may incorporate one or more sensors selected to provide feedback relating to real-time condition of the window or lens being monitored. For example, in the context of a radar sensor, the system may implement a signal reflection and attenuation analysis of radar signals to determine when a window/lens is obstructed and could benefit from cleaning. In one implementation, the monitoring sensor may implement a self-test to compare expected and actual signal strengths, and may determine that cleaning would be beneficial if the system detects a significant signal loss or distortion as compared to expected signal strengths. By having feedback to monitor the surface and sensor quality, the system can use set points or thresholds to predetermine when to automatically clean a surface. As a less proactive alternative to automatically initiating cleaning, the system may be configured to alert the user that the user should clean the surface as shown in FIG. 7B. The sensors used to monitor the windows or lenses may, for example, be radar feedback, lidar feedback, ultrasonic feedback, imaging feedback and even sound monitoring (e.g. wiper scraping over ice) that may enable the system to evaluate the condition of the window/lens and implement or recommend cleaning. With sound monitoring, the system may include a microphone and the system may monitor noise near the wiper to detect sound patterns similar to those caused by a wiper traveling over ice. In some systems, the cleaning system may have an indicator to indicate when the system determines that cleaning needs to happen, it may have an audible indication or it could be placed in an automatic mode to initiate cleaning without user interaction.

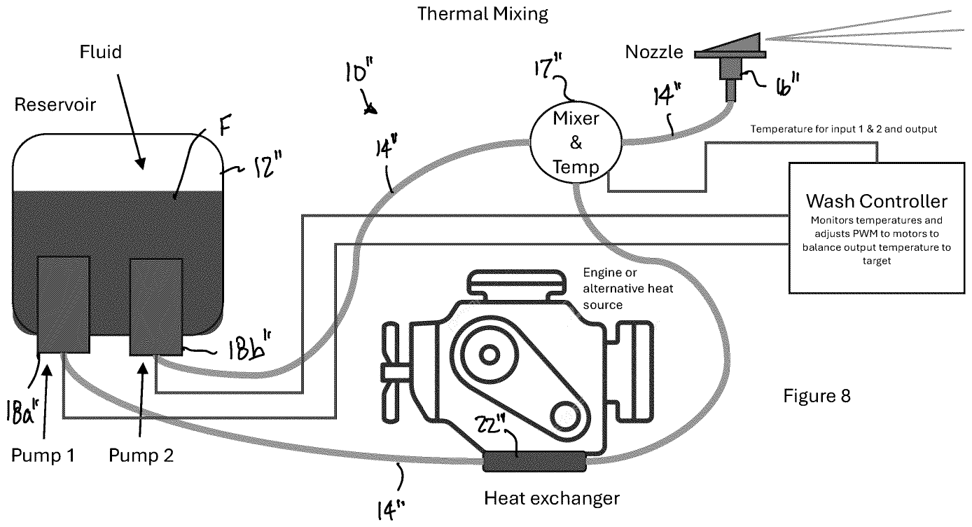

In some applications, the heating system may take advantage of heat energy made available by the engine and/or other vehicle components to heat the fluid. For example, FIG. 8 shows an embodiment of the system 100″ that uses vehicle energy to heat an exchanger 22″. In this embodiment, the system 100″ includes two pumps 18a″ and 18b″ that move fluid F through the system along lines 14″ and allow the mixing of hot fluid passing through the heat exchanger 22″ with cooler fluid that is supplied directly from the reservoir 12″ to achieve a target and controlled temperature. The system 100″ uses several temperature sensors on the fluids to allow a control algorithm to regulate the PWM signals applied to the two pumps 18a″ and 18b″ to control the flow rates to arrive at the target temperature based on ambient conditions. In the illustrated embodiment, the two streams of fluid reunite at a mixer 17″ positioned upstream from the nozzle 16″. The mixing of these two streams of fluids can effectively be used for a minimal configuration of fluid heating. One drawback to this approach is that it may not enable fast enough starts on cold days as the engine must heat up before sufficient heat is available to defrost/deice a windshield. To address the issue of slow start-up, an induction heating system may be added, for example, upstream or downstream from the engine heat exchanger. Although the illustrated embodiment includes two pumps that separately control the flow of fluid, in alternative embodiments, the system may include a single pump and the output of that pump may be split in a controlled manner by a proportional flow-dividing valve that directs one portion of the fluid to the pass through the heat exchanger and the other portion to bypass the heat exchanger. The proportional flow-dividing valve can be controlled to vary the proportion of fluid that is heated versus the portion that is not heated, thereby allowing control over the temperature of fluid output by the nozzle.

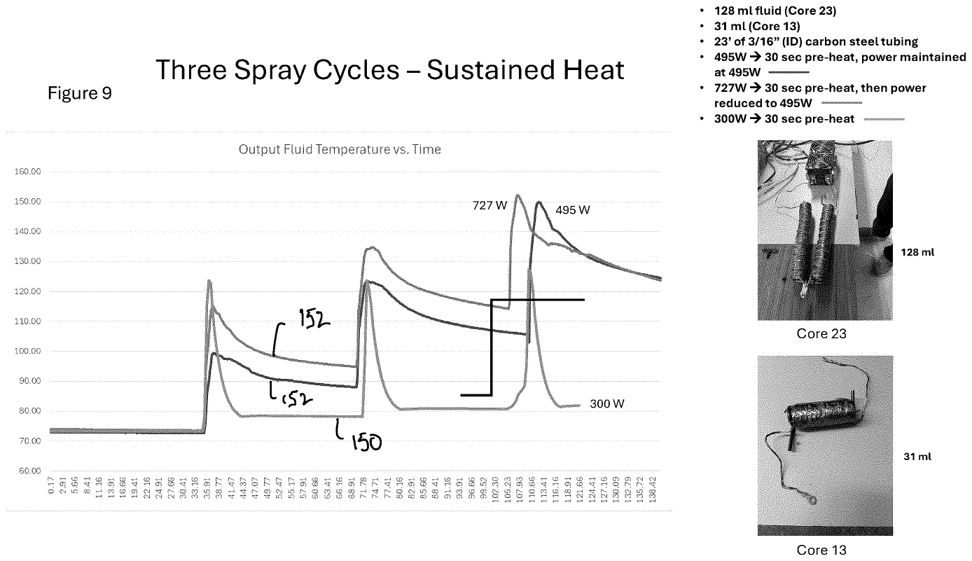

In some embodiments, the control system is designed to operate in environments where there is a limit to the amount of power available for the heating system. In embodiments of this type, the system may be configured to use the available power to build up heat in the system over time, for example, building heat over consecutive cycles. In some embodiments, an appropriate level of energy is delivered into the system as fluid is extracted. In subsequent deployments, the system delivers more thermal energy each time used until reaching the optimal target. The storage of thermal energy in the heat exchanger plays a significant role in assuring the subsequent cycles will eventually be at temperature. FIG. 9 provides a graph of output fluid temperature over time that shows a comparison of three different power schemes applied to exemplary heat exchangers over three consecutive cycles. The orange line 150 plots temperature over time where 300 watts of power are applied to the induction coil and the system allows 30 seconds of preheating prior to each fluid output. This plots shows temperatures achieved using a 31 ml heat exchanger. The green line 152 plots temperature over time where 495 watts of power are applied to the induction coil and the system allows 30 seconds of preheating prior to each fluid output. Finally, the blue line 154 plots temperature over time where the power scheme applies 727 watts to the induction coil for 30 seconds and then power is reduced to 495 watts. The green and blue lines plot temperatures using a 128 ml heat exchanger. These three plots illustrate that the system can achieve higher fluid temperatures even with lower power consumption by heating smaller volumes of fluid. They also show how the heat exchangers function as heat sinks that build energy over time and can build temperature without the need to continually increase energy over time. The orange plot shows that the 300 watt power scheme is sufficient to heat 31 ml of fluid to just under 128° F. in a single cycle. Depending on the volume of fluid to be sprayed in each cycle, this may be sufficient for cleaning in many applications. Comparing the 495 watt and 727 watt power schemes, it can be seen that a relatively short initial period of applying 727 watts has a meaningful impact on the ability of the system to quickly heat 128 ml of fluid. The amount and type of inductively heatable material in the heat exchanger, the fluid volume of the heat exchanger and the power scheme can be varied from application to application to tune the system to meet the needs of different cleaning applications.

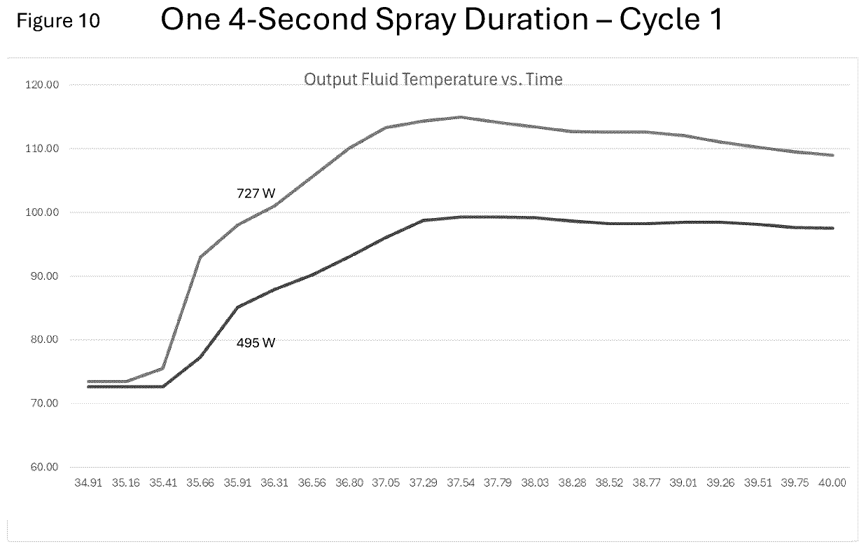

FIG. 10 shows an example of the change (or delta) in temperature for various wattages at a given flow rate. For lower wattage cycles, a few times starts to utilize the stored energy in the system and eventually equilibrates. This allows the system to use less power but defines a control method to assure better results with less power by method of control.

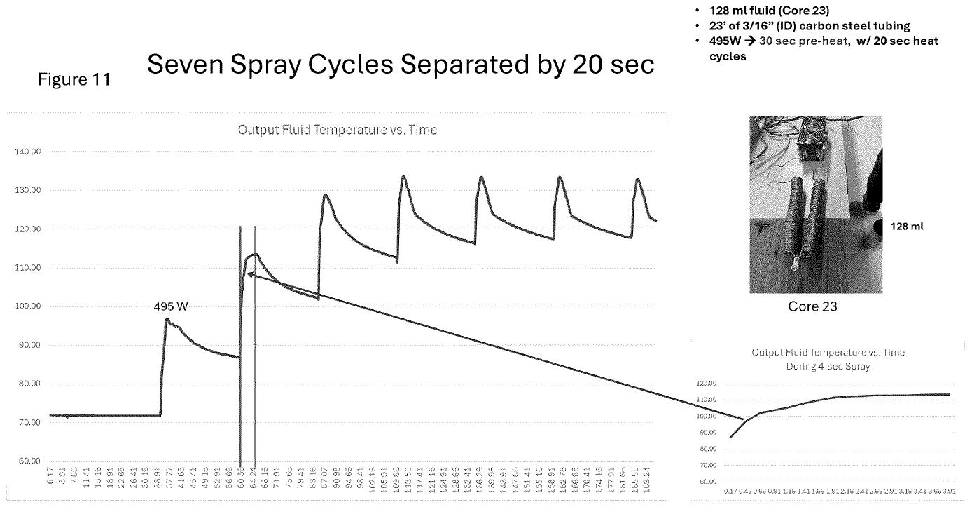

FIG. 11 shows a series of consecutive cycles in a system in which the heat exchanger is configured to function as a heat sink such that an amount of energy is retained in the system after a 30-second preheat cycle, thereby allowing fluid temperature to rise in a relatively short number of consecutive heating/dispensing cycles. As shown, the retained energy enables the next iterations of the spray application to be even more efficacious. In operation, the control system may be configured to tracks this and to reproduce the best case and hold the temperatures as needed. Utilizing a 30-second preheat where the exchanger is preheated to provide first fluid out temperatures closer to target. Note this is with a 30-second preheat cycle.

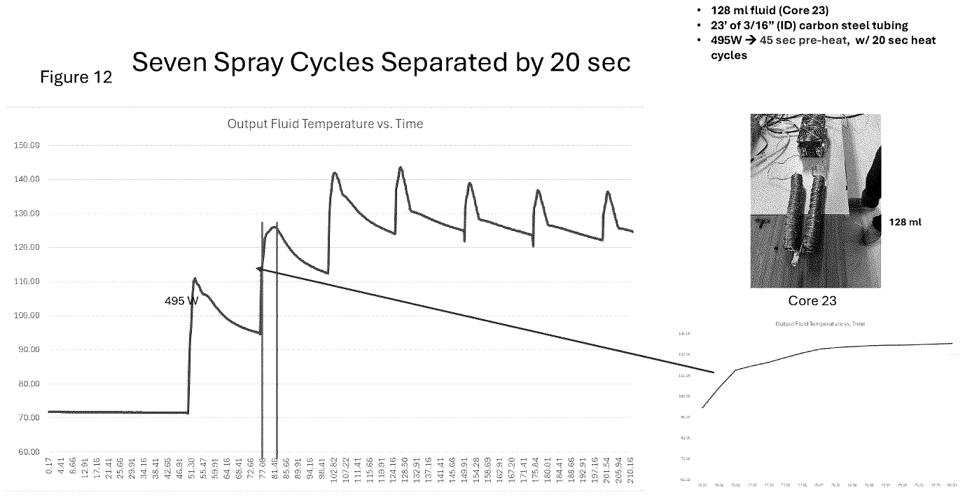

The length of the preheat cycle may vary from application to application, and/or from cycle to cycle in a single application. For example, FIG. 12 shows a plot of temperature over time with a system similar to that associated with FIG. 11, but with 45 second preheat times. As shown, the systems heats fluid to equilibration (e.g. the target temperature) earlier than the 30-second period. By adjusting the preheat cycles and enabling the time to temperature, the system can optimize the delivery and system performance for different applications. This may be implemented as an automatic process for x cycles or as a “ready” indication to a user while applying fluid. The system may also have a delay (potentially, when asked) so that it reaches temperature before applying fluid. For example, the heating system may have a predetermined preheat time or it may determine the preheat time based on then-current characteristics, such as ambient temperature and fluid starting temperature. As another example, the heating system may include a temperature sensor that preheats the fluid until it reaches a temperature set-point. That set point may be predetermined or may be determined in real-time based on then-current characteristics.

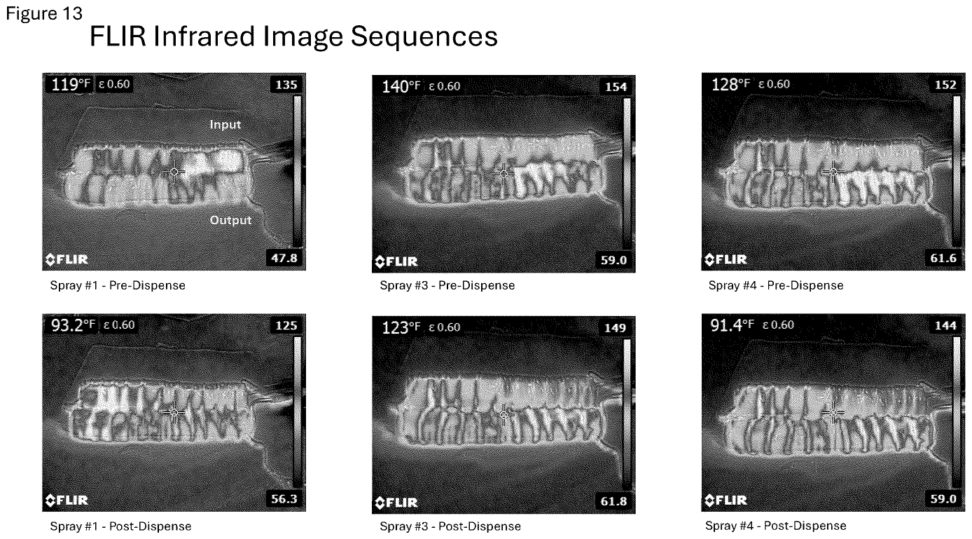

FIG. 13 shows a series of infrared pictures at various time frames during the pre-heating, dispensing and post dispense timing over a number of consecutive preheat/dispense cycles. More specifically, FIG. 13 shows three pairs of images, with each pair including a first image taken after preheating and before dispensing and second image taken after dispensing. The first pair of images were taken before and after the first dispense (or spray). The second pair of images were taken before and after the third dispense. The third pair of images were taken before and after the fourth dispense. In each of these images, the fluid flow starts at the far right of the top coil (labeled “Input” in the first image), flows through the top coil and down to the bottom left of the bottom coil and then right to the outlet on the bottom right (labeled “Output” in the first image). As can be seen, in each post-dispense picture the input region is cooler than the output as some of the heated fluid is dispensed through the output while unheated fluid is introduced at the input. This buildup of thermal energy as the water flows through the system and the cooling at the input is expected. Accordingly, the preheat stage is an equalizer in the control process when the system is not pumping.

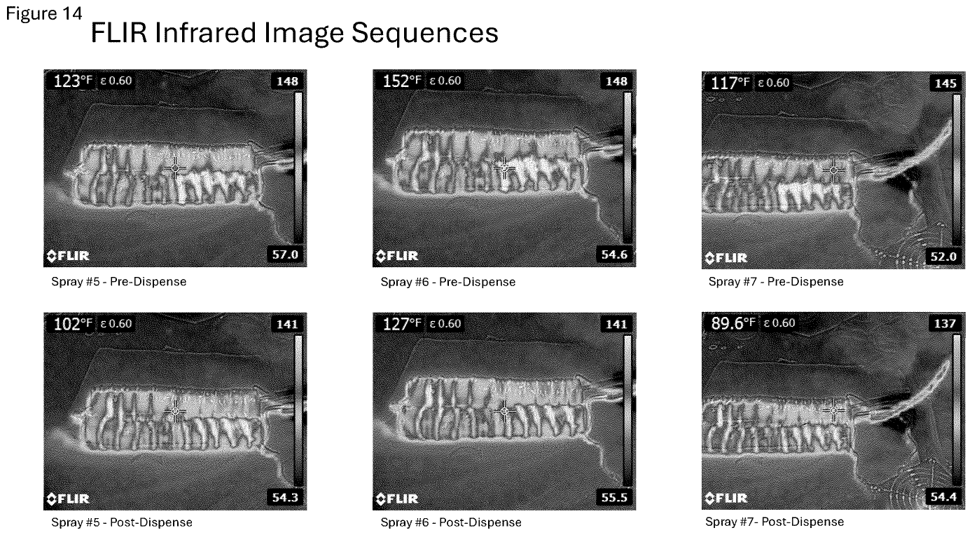

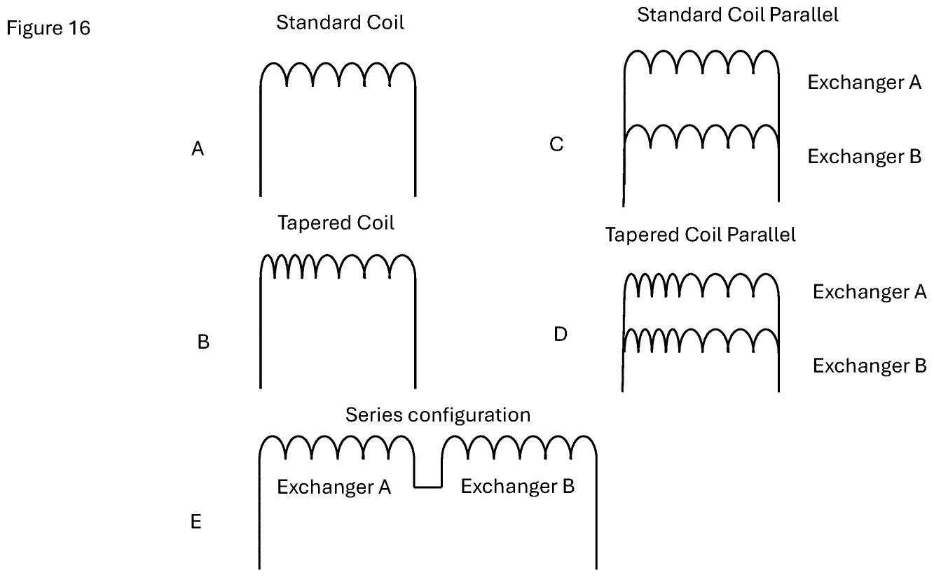

FIG. 14 shows another series of FLIR images and sequences taken before and after the fifth, sixth and seventh dispenses. Again, the input is much cooler than the output temperatures at post-dispense. At pre-dispense we see generally equal inductive heating across the heat transfer coils as a result of the preheating stage. In this application, the system is configured to disperse the inductive field evenly across these transfer coils. However, in other applications, the induction coils may be configured to vary the induction field over space and/or the driver may be configured to vary the inductive field over time. In some applications, the system may be configured to apply compensating fields for areas of cooling, for example, as shown in FIG. 16 with tapered coils B and D that vary the distribution of inductive energy. For instance, the coil may vary by adjusting the spacing between adjacent turns and/or by varying the diameter of the turns. The use of more winding adjacent at or near the input region of the heat exchanger may be used in some applications to compensate for the cooling effect. In designing the specifics of any particular implementation, it may prove helpful to provide a balance of enough metal material for storing thermal energy, a fluid channel that is small enough to heat effectively and a surface area that can be heated inductively.

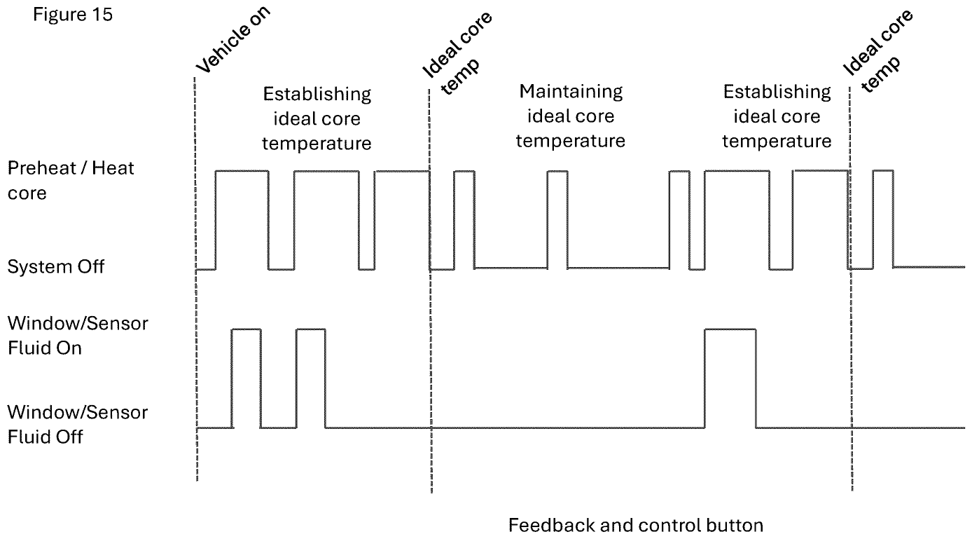

FIG. 15 shows an exemplary control algorithm for preheating and monitoring the preheat and thermal cycling during operation. In this illustration, the top line represents the on/off state of the induction heating system and the bottom line represents the on/off state of the cleaning fluid pump. As shown, the heating system may begin to preheat the heat exchanger even before the pump has been activated to move cleaning fluid through the system. In some applications, the ambient temperature may materially impact heating and may therefore be used to influence these decisions in time. For example, heating may not occur when the ambient temperature is high enough. As another example, heating may be limited so that the temperature difference between the cleaning fluid and the window or lens to be cleaned does not exceed a threshold selected to reduce the risk of thermal shock. In the illustrated control algorithm, the control system attempts to get the system up to speed as quickly as possible. On a cold day where clearing the window or lens is the first task you want to do in the vehicle and it is important to clear your window the system responds by mixing heating with preheating to get the system up to temp. In other words, the rest period or off time gets compressed in order to maintain the highest threshold of thermal energy in the exchanger(s) as fast as possible. In situations where the system is being used more frequently or in the first use of the day operation. This may be based on an estimation of bad conditions such as weather and conditional inputs even AI analysis of these conditions that inform the system performance. By utilizing weather data (directly and/or via the internet), temperature data, time at temp and moisture degree hours we can anticipate the severity of the present, snow, frost and ice conditions. In some embodiments the induction heating system (such as the induction coil(s)) may be susceptible to overheating if subjected to continuous electrical power. More specifically, the electrical resistance of the induction coil may result in resistive heating that is significant enough to affect operation of the system or its impact on surrounding components. Overheating of the induction coil(s) can be addressed in various ways, such as by limiting the magnitude of the power applied to the coil(s), by periodically reducing the magnitude of the power applied to the coil(s) or by applying power to the induction coil(s) in cycles providing an appropriate cooling timeframe between cycles. The power supply scheme shown in FIG. 15 gives the induction coils an opportunity to cool by cycling the application of power to the induction coils, although the control system may be configured to provide a certain amount of non-cycle control at start up. As the system continues to operate, the heat exchanger builds heat from cycle to cycle until enough heat has been stored to allow the cleaning fluid to be heated to target temperatures (typically selected to provide optimal cleaning). As discussed in more detail below, ultrasonics may also be used to assist in the cleaning process.

FIG. 16 shows various induction coil types for specific heating configurations. To provide additional heating power in a given region of the heat exchanger, the induction coils may be designed (e.g. tapered coils) to distribute the energy unevenly where even distribution of power is typically expected. In some applications, the induction coils may include coil modules arranged in series and/or parallel depending on target voltages and desired power levels. These and other variations in the induction coils may provide adjustment to a given power system for target wattage. Given the temperature differences evident in FIGS. 13 and 14, the induction coil(s) may be engineered to more specifically control how the inductive energy is applied. For example, the coil(s) may be configured to heat the input region of the heat exchanger to a higher temperature than the rest of the system or to deliver more energy to the input region even if it does not result in higher temperatures.

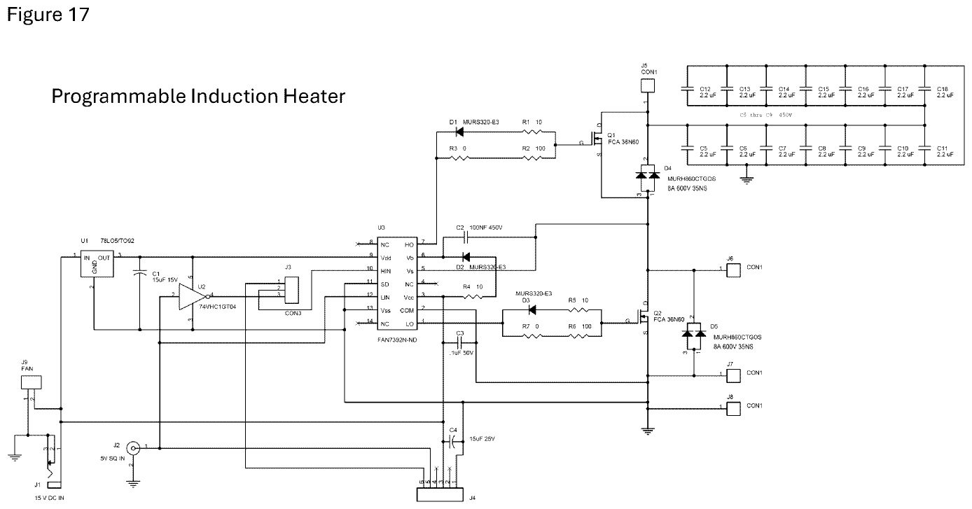

Power may be supplied to the induction coil(s) using any suitable electronics or electrical components. Typically, the heating system will include electronics and/or electrical components that generate and control the supply of high frequency alternating current (“AC”) to the induction coil(s). The heating system may obtain power from an AC mains power supply or from a suitable DC power source. When relying on an AC mains power supply, the heating system may include a rectifier that converts mains power to DC to create a sufficiently stable DC power source. The heating system will also typically include an inverter circuit that functions to convert DC power back to a high-frequency AC with frequency, amplitude and other characteristics tuned for the system. In the illustrated embodiment, the induction coil(s) is paired with a matching capacitor to create a resonant LC circuit (Tank Circuit) to enhance maximum power transfer and efficiency. The tank circuit may be arranged in a series resonant or parallel resonant configuration. In the embodiment shown in FIG. 17, the heating system includes a generally conventional driver. FIG. 17 shows a full bridge driver that is controlled by a microprocessor. For example, the microprocessor may be a digital signal processor (“DSP”) or a microcontroller (“MCU”) with high frequency switching, power regulation and feedback control. In other applications, the system may be controlled by a digital signal controller (“DSC”), a field-programmable gate array (“FPGA”) or an application-specific MCU. The system may include one or more feedback sensors, such as current, voltage and temperature, that assist the controller in regulating power output. The fluid heating system of the illustrated embodiment includes current feedback to understand peak wattage, which can be used to allow the controller to drive to a target wattage or to peak wattage. The control may be predetermined to operate on a less than resonant level and regulate power as voltage changes happen providing a solid control system. Half bridge and other lower cost alternatives may also be used for more basic induction heating.

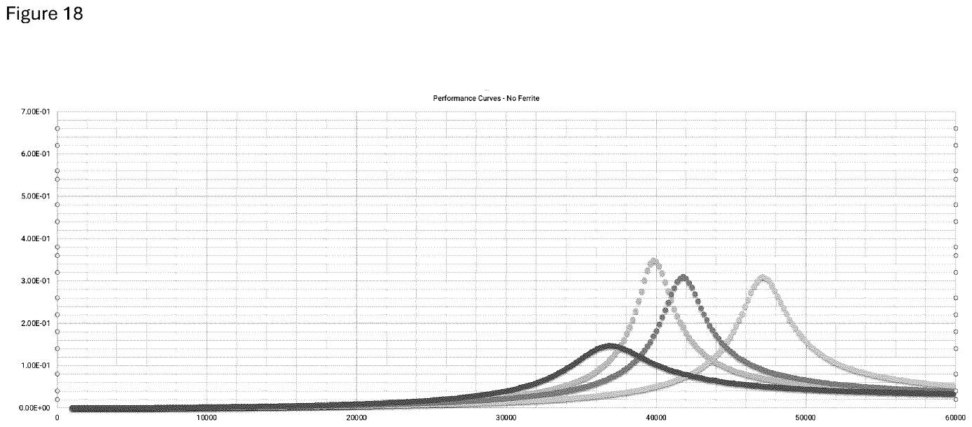

The controller may be configured to optimize the frequency at which power is supplied to the induction coil(s), which may vary based on numerous factors, such as type of material, volume of material and configuration of material. To illustrate, FIG. 18 shows the power response over a frequency sweep for various types of metals. This system can be easily programmed for different metals and materials. The appropriate frequency may be determined in advance, for example, with lab testing; or the system may be configured to determine the appropriate frequency in real-time by monitoring power while sweeping through a range of frequency. Note the ideal control point is on the left side of resonance to a power level the system is capable of and expected to deliver. Frequency, duty cycle or phase control may also be used to regulate the power delivered.

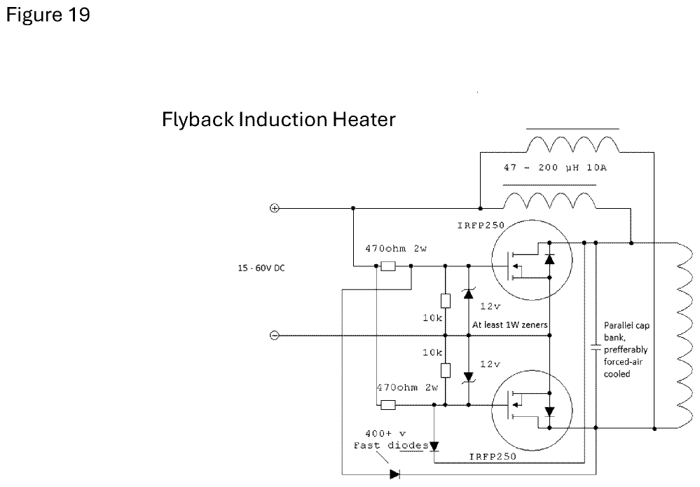

By way of illustration and not limitation, FIG. 19 shows a basic flyback circuit used for induction heating in one embodiment of the present invention. The system includes a current sensor and frequency input for the microprocessor to assure proper operating conditions for safety reasons due to the power being utilized. The flyback is a simple self-resonant seeking circuit, which the controller may be configured to monitor for safety. For example, they may include a current sensor and the controller may be configured to disable or throttle the system to limit the flyback. In some embodiments, the controller may be configured to pull the gate control to off positions or have a secondary power switch that can be operated by the controller to control the flyback for safety and power cycling.

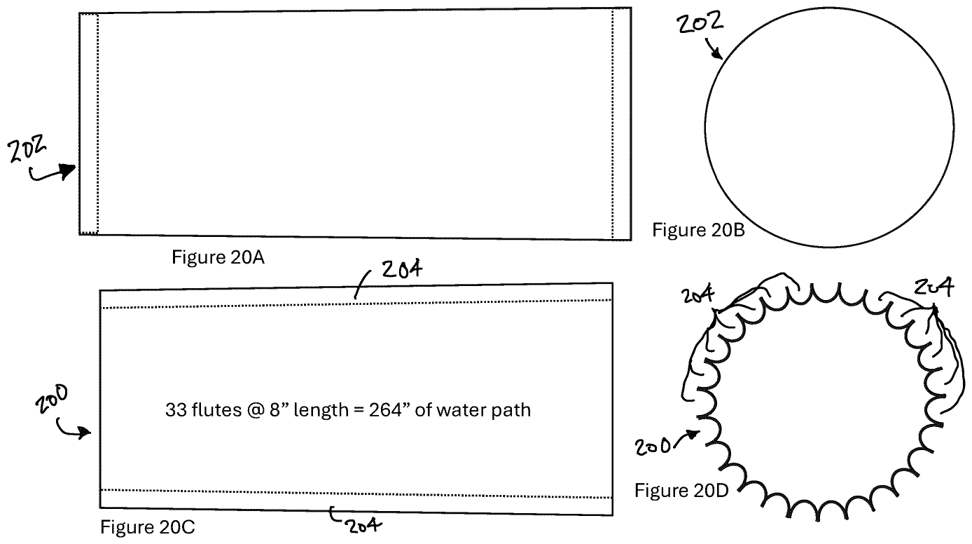

The design and configuration of the heat exchanger may vary from application to application. FIGS. 20A-D show an example of a multi piece heat exchanger with extruded and/or rolled pieces that allow fluid flow and heating over the surface. In this embodiment, the heat exchanger includes a core 200 and a sleeve 202. FIGS. 20A and 20b show the sleeve 202 and FIGS. 20C and 20D show the fluted core 200. In this embodiment, the core 200 is formed from an extrusion with thirty-three (33) flutes 204 that produce about two-hundred and sixty four inches (264″) of flow path over a part that is eight inches (8″) in length. The fluted core 200 is inserted into the sleeve 202 (with a tight enough fit for the inner surface of the sleeve to create a generally leaktight seal with the outermost edges of the flutes 204). The assembly is capped with water routing end caps (or manifolds). These parts can be mixed and matched for various configurations and benefits. The flutes can be connected in different configurations by the manifolds to provide a series flow path, a parallel flow path or a series-parallel flow path. For example, a parallel configuration may be implemented by providing an inlet manifold that receives fluid from the reservoir and distributes it to the first end of each flute so that fluid flows through all of the flutes in parallel. The opposite end of the extrusion may be closed with an outlet manifold that merges the output from all of the flutes back into a single fluid outlet. As another example, the inlet and outlet manifolds may be configured to cause fluid to flow through the flutes in series by routing fluid from one flute to the next in a somewhat zig-zag pattern. Ideal volume, path length and material thickness all contribute to the energy required and the stored energy.

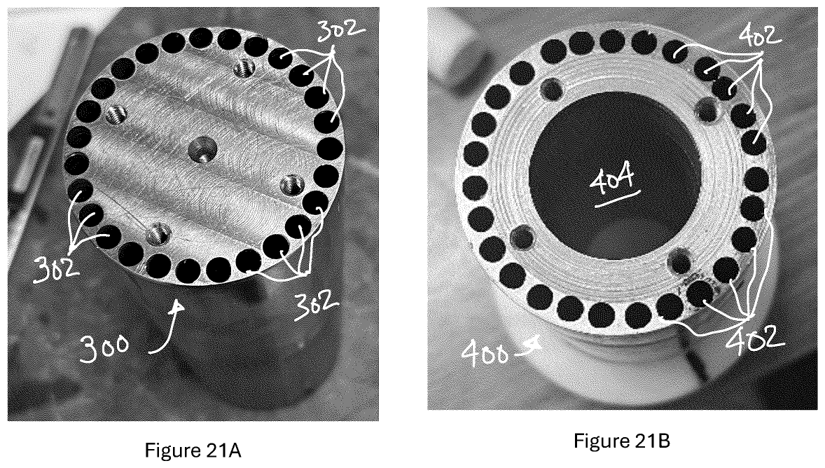

FIG. 21A and B show two different alternative prototype versions of parts that form the primary structure of a heat exchanger. In the embodiment of FIG. 21A, part 300 is a generally solid cylinder with a plurality of parallel through-holes 302 formed side by side around the perimeter of the part. The solid cylinder provides ample bulk of material that can function as a high capacity heat sink, which may facilitate the implementation of a control scheme that builds temperature over time. In this embodiment, each through-hole 302 defines a pathway that is a single fluid path option. The various through-holes 302 can be coupled in different ways to provide series, parallel or series-parallel flow paths. In this embodiment, the specific flow path is configured by end caps (not shown in FIG. 21) that close opposite ends of the part. Internal contours in the end caps can be configured to join the flow paths in various configurations to provide the desired flow rate and path length. The part 400 shown in FIG. 21B is generally identical to the part 300 shown in FIG. 21A including a plurality of through-holes 402 arranged about the perimeter of the cylinder, except that the part 400 is hollow (rather than solid) defining a central through-hole 404. Each configuration has benefits that make it more suitable for certain applications. More material may allow the solid part to store more energy, but it may take more energy to bring the part up to temperature. So, more material may be better in some applications, while less material may be better in others.

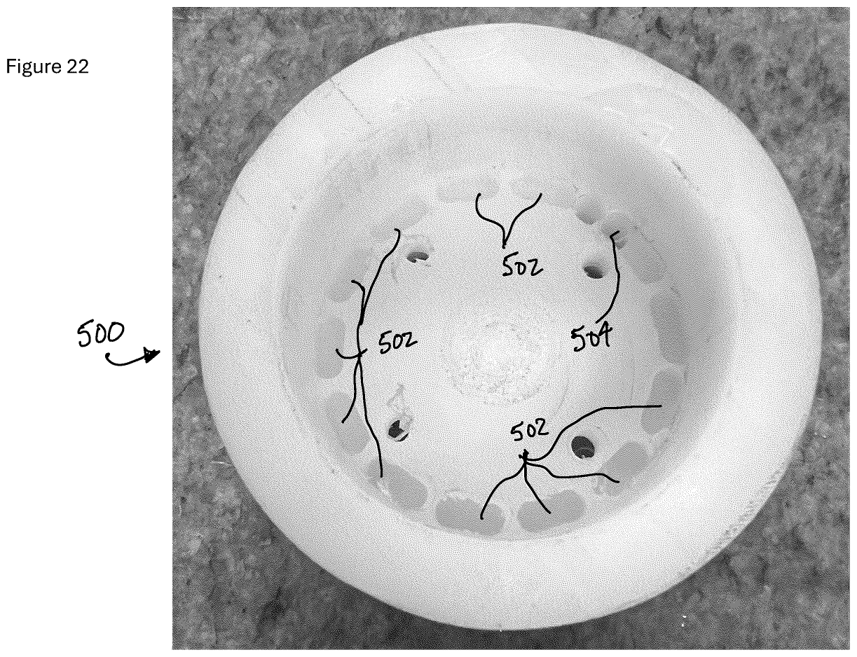

As noted above, the heat exchanger parts (e.g. those shown in FIGS. 21A and 21B) may be closed by end caps (inlet and outlet manifolds). The end caps can be configured, for example, to move water through all of the flutes in parallel or to move the fluid through the flutes one after the other in series. To illustrate, FIG. 22 shows an end cap 500 configured to provide a series flow path. In this embodiment, fluid flow along the part in one direction from one flute is directed by a small connecting channel 502 to the adjacent flute to flow back up the part in the opposite direction. The end cap on the opposite end of the part is configured to complement the illustrated end cap so that the fluid flow path extends back and forth through the part from one flute to the next until the fluid has passed through each flute around the periphery of the part. At the end of the serpentine path, the fluid flows from the part to the nozzle via a through-hole 504. This configuration allows parallel, series and parallel-series configurations to be easily configured as needed for water flow and volume requirements.

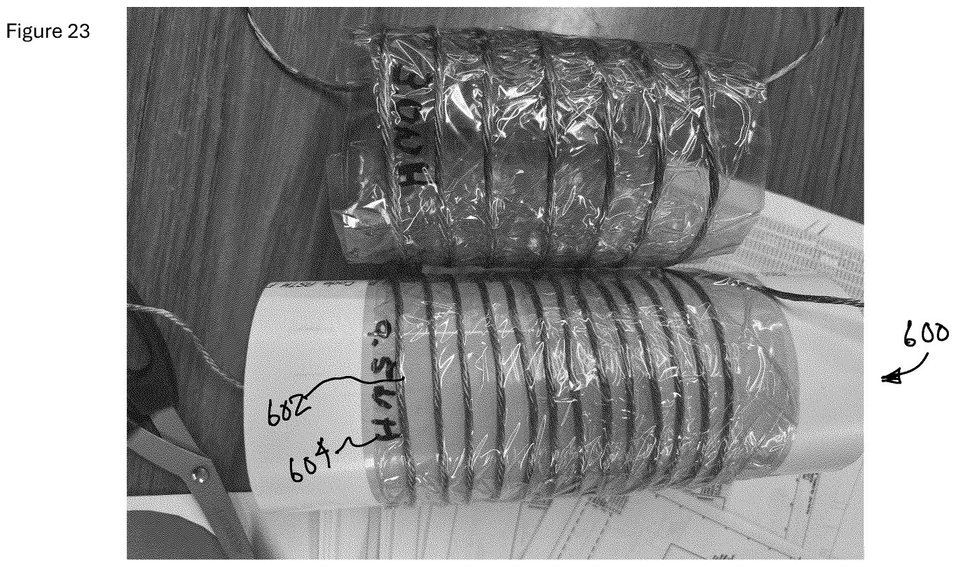

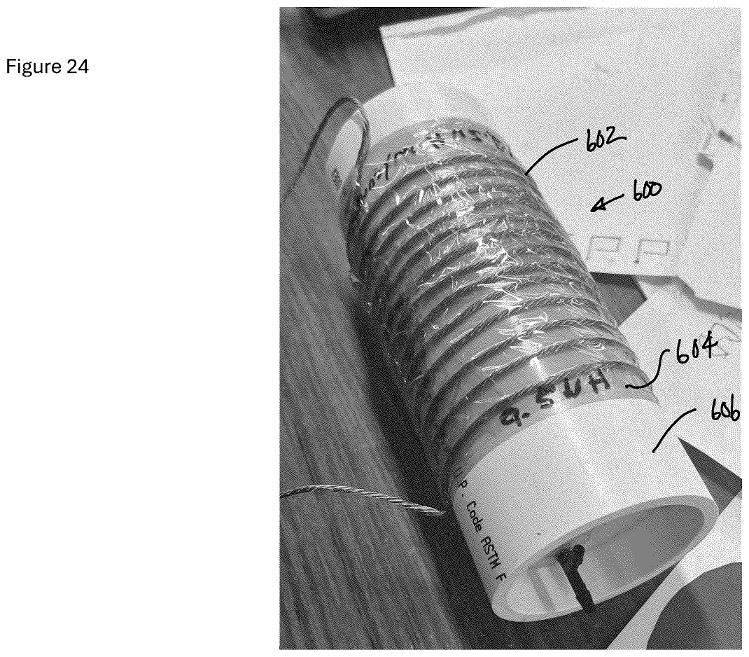

As noted above, the present invention may incorporate a wide variety of alternative induction coils. FIG. 23 shows an induction coil assembly 600 with a simple Kapton tape bobbin 602. In this embodiment, the induction coil 604 is wound and sealed from opposite sides by Kapton tape 602 to prevent environmental influences. As shown, the bobbin can be easily sided over the heat exchanger to make each system intrinsically separate. Although the illustrated embodiment utilizes Kapton tape, the induction coil can be enclosed or sealed by other materials, which may be heat resistant, have non-stick properties and/or be electrically insulative. For example, alternative polyimide-based tapes are available from a variety of suppliers, and various high-temperature electrical tapes are commercially available, including polyester, fiberglass and silicone-based tapes, as well as Mica tape, ceramic fiber tape and PTFE tape. As another example, the induction coil may be enclosed or sealed by any of a variety of moldable materials that may be heat resistant, electrically insulative and/or have non-stick properties. In some applications, the induction coil may be enclosed by silicone-impregnated fiberglass sleeving. Alternatively, the induction coil may be coated with liquid insulation materials, such as conformal coating (e.g. acrylic, silicone or urethane based coatings) or liquid electrical tape (which can be applied as a brush-on or spray-on insulation. FIG. 24 shows the coil 602 and bobbin 604 fitted over a the heat exchanger 606 (inside the bobbin 604). In this embodiment, the heat exchanger has a generally cylindrical shape. It should be understood that the coil and bobbin can be sized and shaped to fit over essentially any heat exchanger.

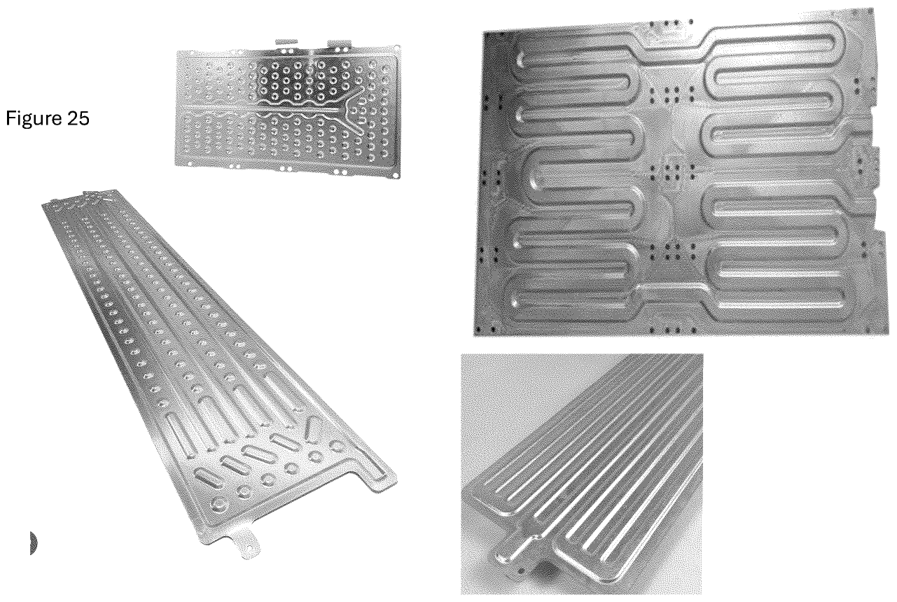

As discussed above, the heat exchanger may include one or more sheets of an inductively heatable material contoured to form or assist in forming a fluid flow path. FIG. 25 shows a variety of different stamped sheets suitable for use in forming a stamped heat exchanger. For example, any of the illustrated sheets may be joined in face-to-face relationship with a mirror image version of a sheet.

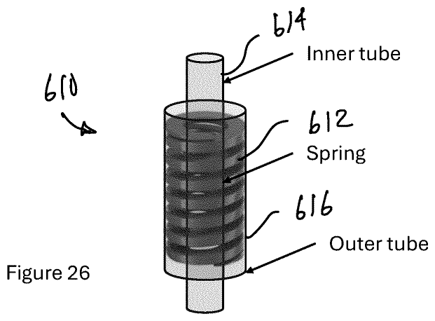

In typical applications, the heat exchanger is configured to provide a serpentine or tortured flow path that increases the dwell time of the fluid in the heat exchanger. For example, FIG. 26 shows an alternative heat exchanger 610 that includes a helically wound flat spring 612 that is disposed between an inner pipe 614 and outer pipe 616. The spring 612, inner pipe 614 and outer pipe 616 cooperatively guide the water path in a helical pattern to increase dwell time and consequently heat exposure. The inner and outer pipes 614, 616 may be manufactured from a material that is inductively heatable, such as iron, steel, nickel, cobalt and other ferrous materials. However, in some applications the inner and/or outer pipes may be manufactured from materials that are not inductively heatable. For example, non-inductively heatable materials may be used for the inner and outer pipes when the spring 612 has a sufficient amount of inductively heatable material.

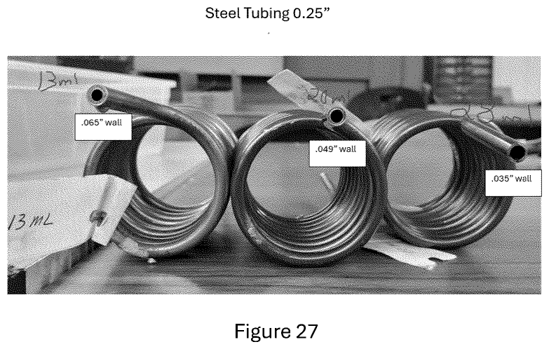

In some applications, the heat exchanger may include a fluid flow path that is defined by a coil of tubing manufactured from an inductively heatable material. FIG. 27 shows different coil systems with various wall thicknesses and masses to provide a balanced heat storage system. Steel tubing is shown in the illustrated embodiments, but the tubing may be manufactured from other materials, including other ferrous metals that are capable of efficiently heating under the influence of an electromagnetic field.

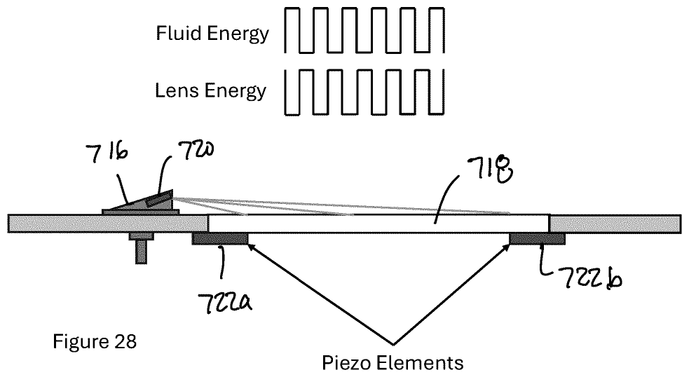

To provide enhanced cleaning, ultrasonic energy may be introduced into the system. For example, the cleaning system may include an ultrasonic module that is configured to inject ultrasonic energy into the system. The ultrasonic module may be configured to inject ultrasonic energy into fluid. For example, the ultrasonic module may include an ultrasonic piezo element (or elements) that introduces ultrasonic vibrations into the fluid. The ultrasonic piezo element(s) may be disposed essentially anywhere along the fluid flow path from the reservoir to the nozzles, but in some applications one or more piezo elements are located at or near the nozzle(s) to optimize the amount ultrasonic energy that remains in the fluid as it impinges on the windshield or lens to be cleaned. In other implementations, the ultrasonic module may be configured to inject ultrasonic energy into the windshield or lens. For example, a piezo element (or a plurality of piezo elements) may be disposed at or near the windshield or lens to create ultrasonic vibrations in the windshield or lens. In some applications, ultrasonic energy may be introduced into the fluid and the windshield/lens. For example, FIG. 28 is a schematic representation of a nozzle 716 positioned adjacent to a lens 718 to be cleaned. In this embodiment, piezo electric elements 720, 722a and 722b are provided to generate ultrasonic vibrations. A first piezo electric element 720 is incorporated into or otherwise position adjacent to the nozzle 716 to introduce ultrasonic energy into the fluid just before it is dispensed from the nozzle 716. Additionally, second and third piezo electric elements 722a and 722b are disposed in contact with the lens 718 to introduce ultrasonic vibrations into the lens 718. As can be seen in the graph shown in FIG. 28, the system may be operated so that the fluid has an ultrasonic energy opposite the lens or surface ultrasonic phase for cleaning energy at the surface.

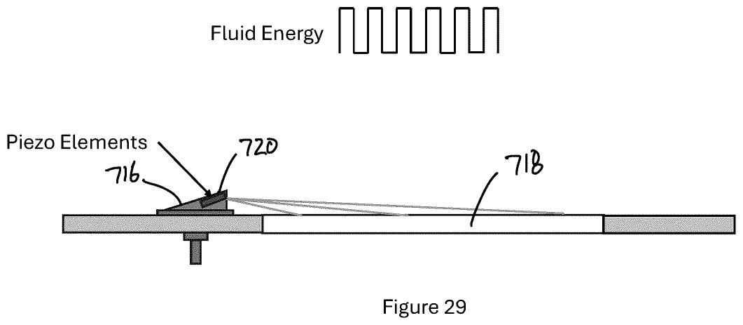

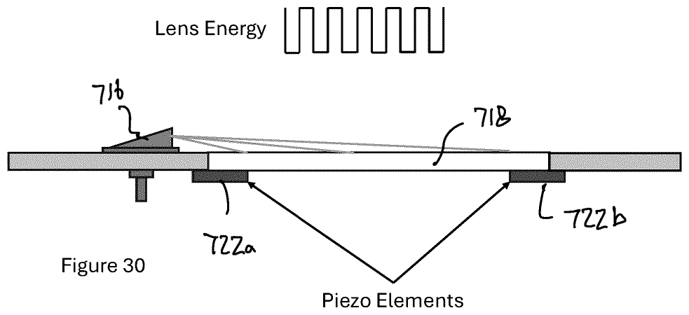

As noted above, the cleaning system includes a pump that moves fluid through the system. To enhance cleaning performance, the pump may be modulated, for example, with pulses. The characteristics of the modulation, such as frequency, amplitude and on/off times, may be selected to provide enhanced performance, and may be varied over time as desired. In some embodiments, modulation of the pump is controlled to produce a water hammer effect giving the fluid greater energy that enhances cleaning. FIG. 28 shows a system in which the ultrasonic energy is alternately introduced into the fluid and into the lens to enhance cleaning performance. For example, the nozzle piezo electric element 720 may be turned on and off in a regular repeating pattern, and the lens piezo electric elements 722a and 722b may be turned on and off in an opposite repeating pattern. Ultrasonic energy can be introduced into the fluid and lens using alternative control schemes. For example, the nozzle and lens piezo element can be pulsed at the same time. The pump may be pulsed or may operate continuously to obtain the best performance. FIG. 29 is a schematic representation of an alternative cleaning system in which ultrasonic energy is introduced only at the nozzle 716, and not at the lens 718. As illustrated, the ultrasonic energy may be introduced into the fluid by operating piezo electric element 720 in alternating on/off periods. The duration and relative length of the on and off periods may vary from application to application or over time. FIG. 30 is a schematic representation of an another alternative cleaning system in which ultrasonic energy is introduced only at the lens 718, and not into the fluid. Ultrasonic energy may be introduced into the lens by operating piezo electric elements 722a and 722b in unison in alternating on/off periods. The duration and relative length of the on and off periods may vary from application to application or over time. Further, the piezo electric elements 722a and 722b can alternatively be independently operated, rather than in unison. All of these combinations may be mixed and matched for cost and efficacy requirements.

In some applications, modulation of the pump and injection of ultrasonic energy may be designed out of phase to provide a scrubbing-like motion at the surface to remove debris. For example, the pump may be modulated with on/off pulses and ultrasonic energy may be introduced into the fluid during one or both of the on/off phases, and ultrasonic energy may be introduced into the windshield or lens during one or both of the on/off phases to introduce energy into the system at the windshield/lens. Any combination of these effects may have a beneficial effect and the decision on what to integrated into a given system may be a balance of cost against cleaning requirements. It should be understood that the illustrated piezo elements are merely exemplary, and that the system may incorporate ultrasonic transducers of different sizes, with larger transducers typically providing greater energy, but coming at greater cost.

In the embodiment shown in FIG. 1, the present invention provides a heating system that includes a fluid reservoir containing a cleaning fluid, a heating chamber separate from the fluid reservoir, a nozzle through which heated fluid is dispensed, fluid supply lines that couple the fluid reservoir to the heating chamber and the heating chamber to the nozzle and a control system configured to move a volume of fluid from the fluid reservoir to the heating chamber, heat the volume of fluid in the heating chamber in isolation from the bulk of fluid in the reservoir and then dispense the heated fluid. In one embodiment, the cleaning fluid is moved using a pump, with the control system configured to periodically operate the pump to move an appropriate volume of fluid into the heating chamber, to allow the cleaning fluid to dwell in the heating chamber to allow it to heat over time and then to operate the pump to dispense an appropriate volume of heated fluid through the nozzle. In one embodiment, the heating chamber is an induction heat exchanger that is heated by an electromagnetic field. The heat exchanger may include a metal tube through which the cleaning fluid is routed between the fluid reservoir and the nozzle. In one embodiment, the metal tube may be arranged in a coil to provide a serpentine flow path for the cleaning fluid.

As discussed above, the heat exchanger may be manufactured in whole or in part from materials capable of being directly heated by an electromagnetic field. For example, ferromagnetic materials, such as iron, nickel, and cobalt, are highly responsive to electromagnetic fields due to their magnetic properties. Ferromagnetic materials generate heat through hysteresis and eddy currents when exposed to alternating magnetic fields. Conductive materials, like copper and aluminum, can be heated via eddy currents induced by electromagnetic fields. These currents create resistive heating within the material. Dielectric materials, such as ceramics or certain polymers, can also be heated using high-frequency electromagnetic fields through dielectric heating. This occurs when the material's polar molecules oscillate and generate heat due to friction. Magnetically permeable materials (i.e. materials with high magnetic permeability), like ferrites, can efficiently absorb electromagnetic energy and convert it into heat. There are also some specialized composites suitable for use in heat exchangers that are engineered with magnetic or conductive inclusions to enable efficient heating when exposed to electromagnetic fields. Further, graphene and carbon materials, such as carbon nanotubes, can interact with electromagnetic fields to produce heat due to their conductive properties.

The material suitable for any particular application may depend on the frequency of the electromagnetic field and the specific application requirements, such as the desired heating rate and energy efficiency.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A fluid cleaning system for automotive applications comprising:
a fluid reservoir configured to contain a bulk volume of fluid;
a heating system configured to heat a volume of fluid, the heating system being separated from the fluid reservoir;
a nozzle to dispense fluid;
a pump configured to move fluid;
a plurality of fluid lines joining the fluid reservoir to the heating system and joining the heating system to the nozzle; and
a controller configured to operate the pump to move a first volume of fluid from the fluid reservoir to the heat exchanger, to retain the first volume of fluid in the heating system for a dwell time, to operate the heating system to heat the first volume of fluid during the dwell time to heat the fluid and to dispense the heated fluid through the nozzle.

2. The fluid cleaning system of claim 1 wherein the heating system includes an inductive coil and a heat exchanger, the inductive coil being disposed adjacent to the heat exchanger, whereby the heat exchanger is heated in the presence of an electromagnetic field generated by the inductive coil.

3. The fluid cleaning system of claim 2 wherein the heat exchanger includes a fluid flow path having at least a portion manufactured from at least one of a ferrous metal or a conductive metal, whereby the heat exchanger can be heated through induction.

4. The fluid cleaning system of claim 3 further including an ultrasonic generator configured to introduce ultrasonic energy into fluid passing through the cleaning system.

5. The fluid cleaning system of claim 3 further including an ultrasonic generator configured to introduce ultrasonic energy into a surface to be cleaned by the cleaning system.

6. The fluid cleaning system of claim 3 wherein the controller is configured to dispense fluid from the cleaning system in pulses.

7. The fluid cleaning system of claim 2 wherein the heat exchanger includes at least one stamped sheet manufactured from a ferrous or conductive metal, the sheet having contours that define a circuitous fluid flow path.

8. The fluid cleaning system of claim 2 wherein the heat exchanger includes a pair of stamped sheets manufactured from a ferrous or conductive metal, the sheets being arranged in face-to-face relation and having contours that cooperatively define a circuitous fluid flow path.

9. The fluid cleaning system of claim 8 wherein the heat exchanger includes a plurality of heat exchanger panels coupled together so that fluid passes through them in series, in parallel or in series-parallel; and
wherein each heat exchanger panel includes at least one stamped sheet manufactured from a ferrous or conductive metal, the sheet having contours that define a circuitous fluid flow path.

10. The fluid cleaning system of claim 9 wherein a separate induction coil is wrapped about each heat exchanger panel.

11. The fluid cleaning system of claim 2 wherein the heat exchanger includes a coil of tubing defining an internal fluid flow path, the coil being manufactured from a material heatable by an electromagnetic field.

12. The fluid cleaning system of claim 11 further including an insulating structure disposed about at least a portion of the heat exchanger.

13. The fluid cleaning system of claim 12 wherein the insulating structure is a ceramic sleeve disposed bout about the heat exchanger.

14. The fluid cleaning system of claim 12 wherein the induction coil is disposed about the insulating structure.

15. The fluid cleaning system of claim 2 wherein the induction coil is formed from tubing defining an internal flow path; and
wherein fluid is routed through the internal flow path in the induction coil to cool the induction coil.

16. A fluid cleaning system for automotive applications comprising:
a fluid reservoir for storing a bulk volume of cleaning fluid;
an inductive heating system arranged in fluid communication with the fluid reservoir;
a nozzle arranged in fluid communication with the inducting heating system;
a pump for moving fluid from the reservoir into the inductive heating system and then to dispense the fluid through the nozzle; and
a control system including an inductive heating driver and an ambient temperature sensor, the control system configured to operate the inducting heating driver as a function of the ambient temperature sensor.

17. The fluid cleaning system of claim 16 wherein the control system further includes a reservoir temperature sensor and a heat exchanger temperature sensor; and
wherein the control system is configured to operate the inducting heating driver as a function of the reservoir temperature sensor, the heat exchanger temperature sensor and the ambient temperature sensor.

18. The fluid cleaning system of claim 16 further including an ultrasonic element for introducing ultrasonic energy into at least one of fluid and a surface to be cleaned; and
wherein the control system include an ultrasonic driver, the driver configured to selectively operate the ultrasonic element.

19. The fluid cleaning system of claim 16 wherein the control system is configured to operate the pump to:
move a volume of fluid from the reservoir to the heat exchanger;
allow the fluid to dwell in the heat exchanger for a preheat period of time; and
dispense the heated fluid through the nozzle.

20. The fluid cleaning system of claim 19 wherein the preheat period of time and the amount of power introduced into induction coils are selected to allow the temperature of the heat exchanger to build over a plurality of consecutive cycles, whereby the temperature of the dispensed fluid may increase over consecutive cycles to reach a desired output temperature.

21. An automotive fluid cleaning system comprising:
a cleaning fluid reservoir containing a bulk volume of cleaning fluid;
a heat exchanger configured to be disposed adjacent to an automobile component that heats during operation of the automobile, the heat exchanger configured to receive fluid from the reservoir;
a fluid mixer for mixing together a first volume of fluid from the heat exchanger and a second volume of fluid from the reservoir;
a fluid dispensing nozzle arranged downstream from the mixer and configured to dispense mixed fluid received from the mixer;
at least one pump for moving fluid from the reservoir through the heat exchanger to the mixer, and for moving fluid from the reservoir to the mixer without passing through the heat exchanger; and
a control system for controlling the proportion at which the first volume of fluid and the second volume of fluid are mixed to control the temperature of the mixed fluid.

22. The automotive fluid cleaning system of claim 21 wherein the at least one pump includes a first pump for moving fluid from the reservoir through the heat exchanger to the mixer and a second pump for moving fluid from the reservoir to the mixer bypassing the heat exchanger.

23. The automotive fluid cleaning system of claim 22 wherein the control system controls a temperature of the dispensed fluid by selectively controlling the flow rates of the first pump and the second pump.

24. The automotive fluid cleaning system of claim 23 further including one or more temperature sensors; and
wherein the control system is configured to control the flow rates of at least one of the first pump and the second pump as a function of temperature readings obtained from one or more the temperature sensors.

25. The automotive fluid cleaning system of claim 21 further including a proportional valve to selectively separates a flow of fluid through the cleaning system into a first portion that that passes through the heat exchanger and a second portion that bypasses the heat exchanger.

26. An automotive fluid cleaning system comprising:
a cleaning fluid reservoir containing a bulk volume of cleaning fluid;
a heat exchanger configured to be heated through induction, the heat exchanger configured to receive fluid from the reservoir;
an induction coil wrapped about the heat exchanger, the induction coil configured to generate an electromagnetic field in response to the supply of an alternating current;
a nozzle for dispensing fluid from the cleaning system;
a pump for moving fluid from the reservoir through the heat exchanger and from the heat exchanger through the nozzle to dispense the fluid onto a surface to be cleaned;
a driver electrically coupled to the induction coil;
a control system with a pump control for controlling operation of the pump to selectively move fluid through the system and a driver control for controlling operation of the driver to supply electrical power to the induction coil.

27. The automotive fluid cleaning system of claim 26 wherein the induction coil includes a plurality of windings coiled about a longitudinal extent, wherein the windings vary along the longitudinal extent to vary the electromagnetic field along the longitudinal extent of the induction coil.

28. The automotive fluid cleaning system of claim 26 wherein the heat exchanger includes a core with a plurality of outwardly opening flutes and an outer shell disposed about the core to close the flutes, whereby the core and the outer shell cooperatively define a plurality of fluid flow paths.

29. The automotive fluid cleaning system of claim 28 wherein the heat exchanger includes an inlet manifold closing a first end and an outlet manifold closing second end.

30. The automotive fluid cleaning system of claim 29 wherein the inlet manifold and outlet manifold cooperatively interconnect the plurality of fluid flow paths in series, parallel or series-parallel.

31. The automotive fluid cleaning system of claim 26 wherein the heat exchanger includes a core defining a plurality of through-holes that provide a plurality of fluid flow paths through the core; and
wherein the heat exchanger further includes an inlet manifold closing a first end and an outlet manifold closing second end, the inlet manifold and outlet manifold cooperatively interconnect the plurality of fluid flow paths in series, parallel or series-parallel.

32. A method for automatically cleaning a surface in an automobile, comprising the steps of:
providing a fluid reservoir containing a bulk volume of cleaning fluid;
providing a heat exchanger configured to selectively heat a volume of fluid, the heat exchanger being separate from the reservoir;
providing an induction heating system for selectively generating an electromagnetic field to inductively heat the heat exchanger and the volume of fluid contained in the heat exchanger;
positioning a nozzle to dispense fluid on surface to be cleaned;
providing a pump for moving a volume of fluid from the reservoir to the heat exchanger for heating and to moving the fluid from the heat exchanger to the nozzle for dispensing on the surface to be cleaned;
providing a control system configured to determine when to initiate a cleaning cycle, the control system including a sensor configured to provide feedback reflective of a current state of the surface to be cleaned, the control system analyzing sensor feedback and determining from such analysis whether to provide an automatic cleaning operation of the cleaning system or to provide an indication that a manual cleaning operation is warranted.

33. The method of claim 32 wherein the sensor is at least one of a radar sensor, a lidar sensor, an ultrasonic sensor and imaging sensor; and
wherein the step of analyzing the sensor feedback includes performing a signal reflection and attenuation analysis.

34. The method of claim 32 wherein the sensor is at least one of a radar sensor, a lidar sensor, an ultrasonic sensor and imaging sensor; and
wherein the step of analyzing the sensor feedback includes performing a comparison of actual signal strength against expected signal strength.
